(19) United States
(12) Patent Application Publication
(10) Pub. No.: US 2026/0351832 A1
(43) Pub. Date: Nov. 5, 2026

(54) VARIABLE RESONATOR AND HIGH-FREQUENCY VARIABLE FILTER CIRCUIT

(71) Applicant: Mitsubishi Electric Corporation, Tokyo (JP)

(72) Inventors: Takeshi OSHIMA, Tokyo (JP); Yu USHIJIMA, Tokyo (JP); Yuta SUGIYAMA, Tokyo (JP); Akimichi HIROTA, Tokyo (JP)

(73) Assignee: Mitsubishi Electric Corporation, Tokyo (JP)

(21) Appl. No.: 19/690,698

(22) Filed: May 28, 2026

Related U.S. Application Data
(63) Continuation of application No. PCT/JP2024/002719, filed on Jan. 30, 2024.

(51) Int. Cl. H01P 7/08; H01P 1/203

(52) U.S. Cl. CPC H01P 7/082; H01P 1/20327

(57) ABSTRACT

A variable resonator includes: a first substrate including a first dielectric substrate, a ground conductor on a back face of the first dielectric substrate, a signal conductor pattern, and a first strip conductor pattern on the front face of the first dielectric substrate with a first end electrically connected to a first side face of the signal conductor pattern, and a second strip conductor pattern on the front face of the first dielectric substrate with a spacing from a second end of the first strip conductor pattern; a second substrate including a second dielectric substrate and a third strip conductor pattern on a back face of the second dielectric substrate such as to face the first and the second strip conductor patterns; and a movable plate connected to a front face of the second substrate, movable by a movable mechanism for moving the second substrate front and back.

### CROSS REFERENCE TO RELATED APPLICATIONS

This application is a Continuation of PCT International Application No. PCT/JP2024/002719 filed on Jan. 30, 2024, which is hereby expressly incorporated by reference into the present application.

### TECHNICAL FIELD

The present disclosure relates to a variable resonator and a high-frequency variable filter circuit, and in particular, to a variable resonator and a high-frequency variable filter circuit used in a communication device in microwave and millimeter wave communication systems.

### BACKGROUND ART

As a high-frequency variable filter circuit used for a communication device in a microwave and millimeter wave communication system, an adjustable microwave filter attracts attention, and Non-Patent Literature 1 describes a 2 GHz low pass filter that is mechanically adjustable.

The low-pass filter disclosed in Non-Patent Literature 1 constituted by a combination of a series inductor and three shunt capacitors, and includes a ground plane on which a transmission line is disposed, the transmission line having three wide portions of different widths constituting the three shunt capacitors on a front face thereof, and a grounded top cover capable of adjusting a distance to the three wide portions by being vertically moved.

### CITATION LIST

### Non-Patent Literatures

Non-Patent Literature 1: T. Michalski, b. Friedmann, and R. Kronberger, “A completely mechanical adjustable 2 GHz low-pass filter,” IEEE Microwave Magazine, vol. 10, no. 1, pp. 140-145, February 2009

### SUMMARY OF INVENTION

### Technical Problem

In the low-pass filter described in Non-Patent Literature 1, since the transmission line disposed in the ground plane and the top cover grounded always operate in a non-contact state, a variable range of a cutoff frequency (GHz) of a passband that is a frequency band for transmitting a high-frequency signal having a frequency of 2 GHz or less that is a set frequency is narrow, and is only about 33% in terms of a ratio.

That is, the variable range of the frequencies to be blocked from among high-frequency signals propagating through the transmission line is narrow.

The present disclosure has been made to solve the above problems, and an object of the present disclosure is to obtain a variable resonator having a wide adjustable range of a resonance frequency that is a frequency at which propagation is blocked among propagating high-frequency signals.

### Solution to Problem

A variable resonator according to the present disclosure includes: a first substrate including a first dielectric substrate, a ground conductor disposed on a back face of the first dielectric substrate, a signal conductor pattern disposed on a front face of the first dielectric substrate, a first strip conductor pattern disposed on the front face of the first dielectric substrate and having a first end electrically connected to a first side face of the signal conductor pattern, and a second strip conductor pattern disposed on the front face of the first dielectric substrate with a spacing from a second end of the first strip conductor pattern; a second substrate including a second dielectric substrate and a third strip conductor pattern disposed on a back face of the second dielectric substrate in such a manner as to face the first strip conductor pattern and the second strip conductor pattern; and a movable plate connected to a front face of the second substrate, and movable in a front and back direction of the second substrate by a movable mechanism for moving the second substrate in the front and back direction, to adjust a distance between a front face of the first substrate and a back face of the second substrate.

### Advantageous Effects of Invention

According to the present disclosure, in particular, in a variable resonator used in a communication device in a microwave and millimeter wave communication system, a variable frequency range that is mechanically adjustable with respect to a resonance frequency at which propagation is blocked among propagating high-frequency signals is wide.

### BRIEF DESCRIPTION OF DRAWINGS

FIG. 1 is an exploded perspective view illustrating a variable resonator according to a first embodiment.

FIG. 2 is a plan view illustrating a first substrate in the variable resonator according to the first embodiment as viewed from a front face.

FIG. 3 is a perspective plan view illustrating a second substrate in the variable resonator according to the first embodiment as viewed from the front face.

FIG. 4 is a perspective view illustrating the variable resonator according to the first embodiment.

FIG. 5 is a plan view illustrating the variable resonator according to the first embodiment as viewed from the front face.

FIG. 6 is a right side perspective view illustrating the variable resonator according to the first embodiment.

FIG. 7 is a front perspective view illustrating the variable resonator according to the first embodiment.

FIG. 8 is a partially enlarged view of a cross section taken along line I-I in FIG. 5.

FIG. 9 is a partially enlarged view of a cross section taken along line II-II in FIG. 5.

FIG. 10 is a circuit diagram illustrating an equivalent circuit of the variable resonator according to the first embodiment.

FIG. 11 is a circuit diagram illustrating an equivalent circuit of the variable resonator according to the first embodiment.

FIG. 12 is a perspective view illustrating a variable resonator according to a second embodiment.

FIG. 13 is a plan view illustrating the variable resonator according to the second embodiment as viewed from the front face.

FIG. 14 is a plan view illustrating a first substrate in the variable resonator according to the second embodiment as viewed from the front face.

FIG. 15 is a perspective plan view illustrating a second substrate in the variable resonator according to the second embodiment as viewed from the front face.

FIG. 16 is a circuit diagram illustrating an equivalent circuit according to the second embodiment.

FIG. 17 is a perspective plan view illustrating another example 1 of the second substrate in the variable resonator according to the second embodiment as viewed from the front face.

FIG. 18 is a perspective plan view illustrating another example 2 of the second substrate in the variable resonator according to the second embodiment as viewed from the front face.

FIG. 19 is a perspective plan view illustrating another example 3 of the second substrate in the variable resonator according to the second embodiment as viewed from the front face.

FIG. 20 is an exploded perspective view illustrating a high-frequency variable filter circuit according to a third embodiment.

FIG. 21 is a perspective view illustrating a variable resonator according to the third embodiment.

FIG. 22 is a plan view illustrating the high-frequency variable filter circuit according to the third embodiment as viewed from the front face.

FIG. 23 is a plan view illustrating a first substrate in the high-frequency variable filter circuit according to the third embodiment as viewed from the front face.

FIG. 24 is a perspective plan view illustrating a second substrate in the high-frequency variable filter circuit according to the third embodiment as viewed from the front face.

FIG. 25 is a partially enlarged view of a cross section taken along line III-III in FIG. 22.

FIG. 26 is a partially enlarged view of a cross section taken along line IV-IV in FIG. 22.

FIG. 27 is a partially enlarged view illustrating cross sections taken along respective lines V-V and VI-VI in FIG. 22.

FIG. 28 is a circuit diagram illustrating an equivalent circuit of the variable resonator according to the third embodiment.

FIG. 29 is a circuit diagram illustrating an equivalent circuit of the variable resonator according to the third embodiment.

FIG. 30 is a circuit diagram illustrating an equivalent circuit representing operation at a frequency of a second-order harmonic (second harmonic) of a fundamental wave in the variable resonator according to the third embodiment.

FIG. 31 is a circuit diagram illustrating an equivalent circuit representing operation at a frequency of a third-order harmonic (third harmonic) of the fundamental wave in the variable resonator according to the third embodiment.

FIG. 32 is a circuit diagram illustrating an equivalent circuit representing operation in the vicinity of a cutoff frequency through which the fundamental wave passes in the variable resonator according to the third embodiment.

FIG. 33 is a perspective view illustrating a high-frequency variable filter circuit according to a fourth embodiment.

FIG. 34 is a plan view illustrating a first substrate in a variable resonator according to the fourth embodiment as viewed from a front face.

FIG. 35 is a perspective plan view illustrating a second substrate in the variable resonator according to the fourth embodiment as viewed from the front face.

FIG. 36 is a perspective plan view illustrating another example 1 of the second substrate in the variable resonator according to the fourth embodiment when viewed from the front face.

FIG. 37 is a perspective plan view illustrating another example 2 of the second substrate in the variable resonator according to the fourth embodiment when viewed from the front face.

FIG. 38 is a perspective plan view illustrating another example 3 of the second substrate in the variable resonator according to the fourth embodiment when viewed from the front face.

FIG. 39 is a perspective view illustrating a high-frequency variable filter circuit according to a fifth embodiment.

FIG. 40 is a plan view illustrating a first substrate in a variable resonator according to the fifth embodiment as viewed from a front face.

FIG. 41 is a perspective plan view illustrating a second substrate in the variable resonator according to the fifth embodiment as viewed from the front face.

FIG. 42 is a perspective plan view illustrating another example 1 of the second substrate in the variable resonator according to the fifth embodiment as viewed from the front face.

### DESCRIPTION OF EMBODIMENTS

### First Embodiment

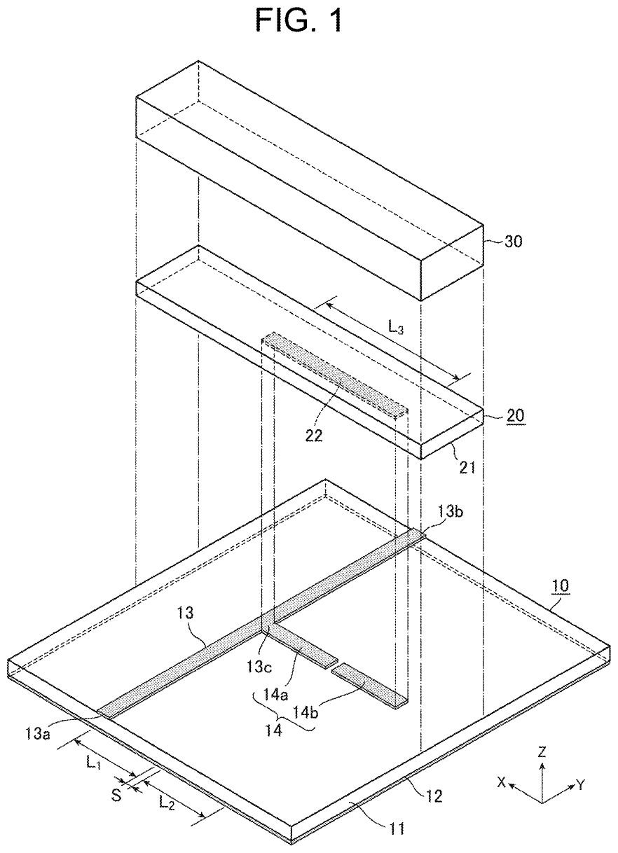

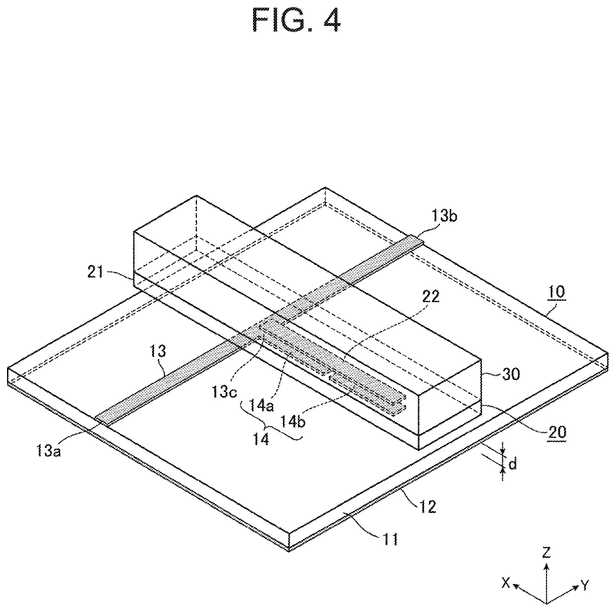

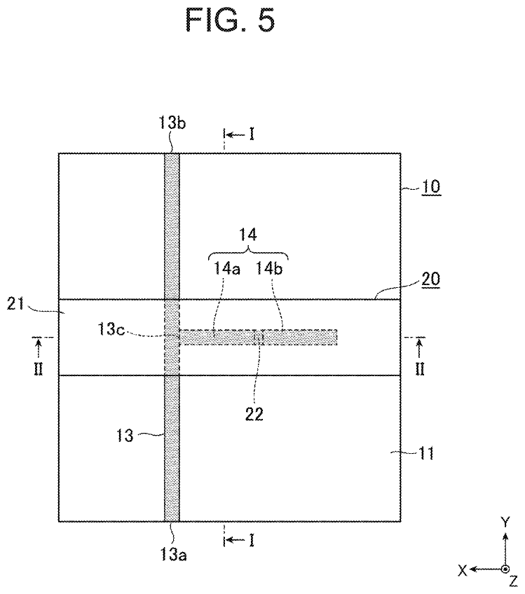

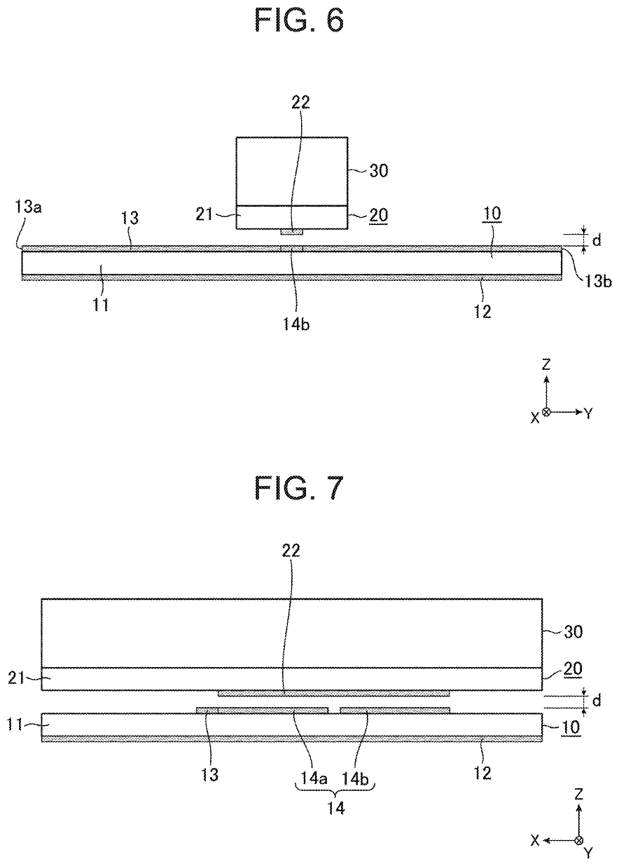

A variable resonator according to a first embodiment will be described with reference to FIGS. 1 to 11.

The variable resonator according to the first embodiment is particularly used for a high-frequency variable filter circuit used in a communication device in a microwave and millimeter wave communication system, for example, a low-pass filter capable of mechanically adjusting a cutoff frequency.

As illustrated in FIGS. 1 to 9, the variable resonator according to the first embodiment includes a first substrate 10, a second substrate 20, and a movable plate 30.

The first substrate 10 is a microstrip substrate having a microstrip line that transmits a high-frequency signal including an electromagnetic wave.

The first substrate 10 includes a first dielectric substrate 11, a ground conductor (ground conductor) 12, a signal conductor pattern 13, and a stub conductor pattern 14.

In the drawing, for convenience, on a front face parallel to a front face of the first dielectric substrate 11, a direction orthogonal to a longitudinal direction of the signal conductor pattern 13 is an X direction, the longitudinal direction of the signal conductor pattern 13 is a Y direction, and a front and back direction of the first dielectric substrate 11 is a Z direction.

The ground conductor 12 is a conductor foil, for example, a copper foil, formed on the back face of the first dielectric substrate 11 having a planar shape, for example, the entire back face in FIG. 1.

The signal conductor pattern 13 is a microstrip line formed on the front face of the first dielectric substrate 11, and constitutes a signal transmission line together with the ground conductor 12, with the first dielectric substrate 11 interposed therebetween.

The signal conductor pattern 13 is a linear conductor foil having a width W, for example, a copper foil.

A first end of the signal conductor pattern 13 is a first input and output terminal 13a, and a second end of the signal conductor pattern 13 is a second input and output terminal 13b.

Note that the description has been given assuming that the input and output terminal includes both of an input terminal and an output terminal for a high-frequency signal, and that one input and output terminal is an input end and the other input and output terminal is fixed to the output end.

In addition, the first input and output terminal 13a may refer to a first input and output terminal disposed on the front face of the first dielectric substrate 11 and electrically connected to the first end of the signal conductor pattern 13, and the second input and output terminal 13b may refer to a second input and output terminal disposed on the front face of the first dielectric substrate 11 and electrically connected to the second end of the signal conductor pattern 13.

The stub conductor pattern 14 includes a first strip conductor pattern 14a and a second strip conductor pattern 14b.

The first strip conductor pattern 14a is a strip line formed on the front face of the first dielectric substrate 11, and constitutes a first stub transmission line together with the ground conductor 12, with the first dielectric substrate 11 interposed therebetween.

The first strip conductor pattern 14a is a linear conductor foil having a length L₁, for example, a copper foil.

A first end of the first strip conductor pattern 14a is electrically connected to a first side face of the signal conductor pattern 13, and a second end of the first strip conductor pattern 14a is an open end.

The first strip conductor pattern 14a and the signal conductor pattern 13 are conductor foils integrally formed, a first end of the first strip conductor pattern 14a and the first side face of the signal conductor pattern 13 are not physically separated, and a boundary face between the first strip conductor pattern 14a and the signal conductor pattern 13 is referred to as the first side face of the signal conductor pattern 13.

The first strip conductor pattern 14a is disposed on the front face of the first dielectric substrate 11 orthogonal to the signal conductor pattern 13.

A connection point between the first end of the first strip conductor pattern 14a and a side portion of the signal conductor pattern 13 is referred to as a connection portion 13c.

The second strip conductor pattern 14b is a strip line formed on the front face of the first dielectric substrate 11, and constitutes a second stub transmission line together with the ground conductor 12, with the first dielectric substrate 11 interposed therebetween.

The second strip conductor pattern 14b is a linear conductor foil having a length L₂, for example, a copper foil.

Both ends of the second strip conductor pattern 14b are open ends, and an open end located at the first end of the second strip conductor pattern 14b is disposed with a spacing S from the second end of the first strip conductor pattern 14a.

The second strip conductor pattern 14b is disposed on an extension line of the first strip conductor pattern 14a.

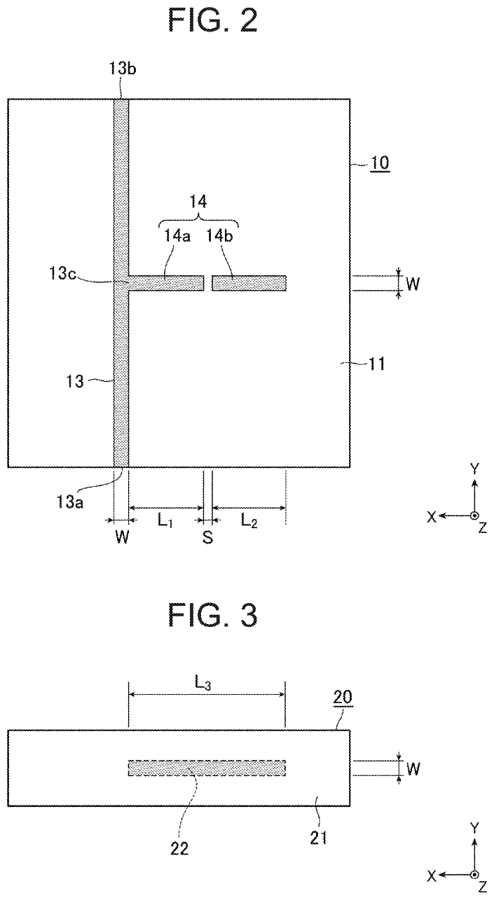

That is, as illustrated in FIG. 2, the first strip conductor pattern 14a and the second strip conductor pattern 14b are arranged along a straight line in the X direction with the spacing S therebetween on the front face of the first dielectric substrate 11.

A width W of the first strip conductor pattern 14a and a width W of the second strip conductor pattern 14b are the same.

The width W of the first strip conductor pattern 14a and the width W of the second strip conductor pattern 14b are preferably the same as, or may be different from, the width W of the signal conductor pattern 13.

The second substrate 20 includes a coupling degree adjusting conductor pattern for adjusting a coupling degree that is a ratio of electromagnetic field coupling with the stub conductor pattern 14 in the first substrate 10, and is a coupling degree adjusting substrate vertically moved with respect to the first substrate 10.

The second substrate 20 includes a second dielectric substrate 21 and a third strip conductor pattern 22.

The second substrate 20 is disposed in such a manner as to face the first substrate 10, and is vertically moved with respect to the first substrate 10.

The movable plate 30 having a planar shape is connected to the front face of the second substrate 20.

The movable plate 30 is attached to a movable mechanism (not illustrated) for moving the second substrate 20 in the front and back direction, and is moved (vertically moved) in the front and back direction of the second substrate 20 by the movable mechanism.

The movable plate 30 is moved in the front and back direction (Z direction) of the second substrate 20 by the movable mechanism, so that the distance between the front face of the first substrate 10 and the back face of the second substrate 20 is adjusted.

That is, a back face of the second dielectric substrate 21 having a planar shape in the second substrate 20 and the front face of the first dielectric substrate 11 having a planar shape in the first substrate 10 are disposed in such a manner as to face each other, and the second substrate 20 is vertically moved with respect to the front face of the first substrate 10.

Note that, in the first embodiment, the second substrate 20 is vertically moved with respect to the first substrate 10, but the first substrate 10 may be vertically moved with reference to the back face of the second substrate 20.

In short, it is sufficient that the second substrate 20 is relatively moved vertically with respect to the first substrate 10.

The movable mechanism is various actuators such as a voice coil motor or a moving coil actuator, and a plunger or the like in the actuator is connected to the movable plate 30 to vertically move the movable plate 30.

Note that, in a case where an actuator is used, by making the drive of the actuator free, a state in which a distance d is zero (d=0) is formed by the weight of the actuator, so that the electrical origin can be easily obtained.

The distance d is a spacing between a front face of the conductor pattern arranged on the front face of the first substrate 10 and a front face of the conductor pattern arranged on the back face of the second substrate 20.

The third strip conductor pattern 22 is a coupling degree adjusting conductor pattern for adjusting a coupling degree k that is a ratio of electromagnetic field coupling with the stub conductor pattern 14 in the first substrate 10.

The third strip conductor pattern 22 is disposed on the back face of the second dielectric substrate 21 in such a manner as to face the first strip conductor pattern 14a and the second strip conductor pattern 14b.

That is, the third strip conductor pattern 22 is located immediately above the first strip conductor pattern 14a and the second strip conductor pattern 14b.

The third strip conductor pattern 22 is a linear conductor foil having a length L₃, for example, a copper foil.

As illustrated in FIG. 9, the length L₃ of the third strip conductor pattern 22 is the sum of the length L₁ of the first strip conductor pattern 14a, the length L₂ of the second strip conductor pattern 14b, and the spacing S between the first strip conductor pattern 14a and the second strip conductor pattern 14b.

As illustrated in FIG. 3, the width W of the third strip conductor pattern 22 is the same as the width W of the first strip conductor pattern 14a and the width W of the second strip conductor pattern 14b.

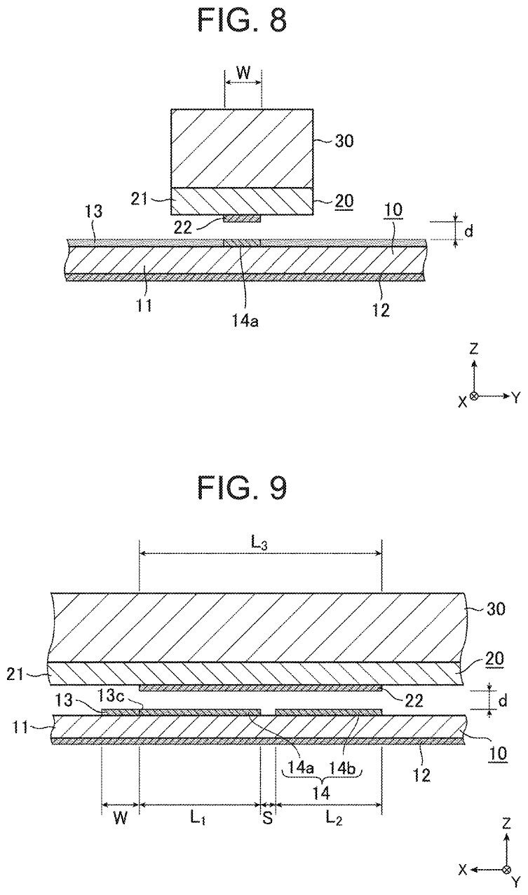

The third strip conductor pattern 22 is a strip conductor parallel to the first strip conductor pattern 14a and the second strip conductor pattern 14b and, when having a distance d (see FIGS. 8 and 9) from the first strip conductor pattern 14a and the second strip conductor pattern 14b with electromagnetic field coupling ranging from tight coupling to loose coupling, forms a coupled line with the first strip conductor pattern 14a and the second strip conductor pattern 14b.

The tight coupling refers to a state of a coupled line constituted by the third strip conductor pattern 22, the first strip conductor pattern 14a, and the second strip conductor pattern 14b at the moment (d≈0) when the distance d is substantially 0, that is, the third strip conductor pattern 22 is separated from the contact state with the first strip conductor pattern 14a and the second strip conductor pattern 14b, and the coupling degree k≈1, which is a ratio of electromagnetic field coupling.

Further, the loose coupling refers to a state immediately before the distance d between the third strip conductor pattern 22 and the first strip conductor pattern 14a and the second strip conductor pattern 14b becomes sufficiently large such that the coupled line is no longer configured by the third strip conductor pattern 22, the first strip conductor pattern 14a, and the second strip conductor pattern 14b, and the coupling degree k≈0, which is the ratio of electromagnetic field coupling, is satisfied.

In short, the third strip conductor pattern 22 is vertically moved by the second substrate 20 being vertically moved in a range from a contact state (coupling degree k=1) with the first strip conductor pattern 14a and the second strip conductor pattern 14b to a state sufficiently away from each other (coupling degree k=0).

Next, propagation wavelengths and resonance frequencies of high-frequency signals by stub transmission lines formed by the third strip conductor pattern 22, the first strip conductor pattern 14a, and the second strip conductor pattern 14b will be described.

When the third strip conductor pattern 22 is in contact with the first strip conductor pattern 14a and the second strip conductor pattern 14b, that is, when the distance d=0 is satisfied and the coupling degree k=1, which is the ratio of electromagnetic field coupling, is satisfied, the third strip conductor pattern 22, the first strip conductor pattern 14a, and the second strip conductor pattern 14b are in an electrical conduction state, and thus it is equivalent to the stub conductor pattern having the length L₃ being electrically connected to the connection portion 13c in the signal conductor pattern 13.

Therefore, the propagation wavelengths of the high-frequency signals propagating through the stub transmission lines formed by the third strip conductor pattern 22, the first strip conductor pattern 14a, and the second strip conductor pattern 14b are determined by the thickness and the dielectric constant of the first dielectric substrate 11, the thickness and the dielectric constant of the second dielectric substrate 21, the width and the thickness in the third strip conductor pattern 22, the first strip conductor pattern 14a, and the second strip conductor pattern 14b, and the frequency.

Here, the length L₃ of the third strip conductor pattern 22 is set to be ¼ of the propagation wavelength at the first resonance frequency f_{0L}.

As a result, the stub transmission line formed by the third strip conductor pattern 22, the first strip conductor pattern 14a, and the second strip conductor pattern 14b operates as a ¼-wavelength open-ended stub in which an electrical short-circuit point is formed in the connection portion 13c in the signal conductor pattern 13 at the first resonance frequency f_{0L}.

The first resonance frequency f_{0L} is a lower limit of the frequencies at which propagation is blocked from among the high-frequency signals propagating to the signal conductor pattern 13.

Therefore, in the signal conductor pattern 13, among the high-frequency signals input from the first input and output terminal 13a, the high-frequency signals at the first resonance frequency f_{0L} and at frequencies in the vicinity including the first resonance frequency f_{0L} are attenuated by the ¼-wavelength open-ended stub, and are prevented from passing to the second input and output terminal 13b.

When the distance d between the third strip conductor pattern 22 and each of the first strip conductor pattern 14a and the second strip conductor pattern 14b is sufficiently large and the coupling degree k=0, which is the ratio of electromagnetic field coupling, is satisfied, the first strip conductor pattern 14a and the second strip conductor pattern 14b are not affected by the third strip conductor pattern 22, and thus it is electrically equivalent to the first strip conductor pattern 14a having the length L₁ being connected to the connection portion 13c in the signal conductor pattern 13 as the stub conductor pattern.

Therefore, the propagation wavelengths of the high-frequency signals propagating through the stub transmission line formed by the first strip conductor pattern 14a are determined by the thickness and dielectric constant of the first dielectric substrate 11, the width and thickness of the first strip conductor pattern 14a, and the frequency.

Here, the length L₁ of the first strip conductor pattern 14a is set to be ¼ of the propagation wavelength at the second resonance frequency f_{0H}.

As a result, the stub transmission line formed by the first strip conductor pattern 14a operates as a ¼-wavelength open-ended stub in which an electrical short-circuit point is formed in the connection portion 13c in the signal conductor pattern 13 at the second resonance frequency f_{0H}.

The second resonance frequency f_{0H} is an upper limit frequency at which propagation of the high-frequency signals propagating to the signal conductor pattern 13 is blocked.

The second resonance frequency f_{0H} is set to twice the first resonance frequency f_{0L} (f_{0H}=2×f_{0L}), and the length L₃ of the third strip conductor pattern 22 is set to approximately twice the length L₁ of the first strip conductor pattern 14a (L₃≈2×L₁).

The length L₂ of the second strip conductor pattern 14b is set to a length (L₂≈L₃−L₁−S) obtained by subtracting the sum of the length L₁ of the first strip conductor pattern 14a and the spacing S between the second end of the first strip conductor pattern 14a and the first end of the second strip conductor pattern 14b from the length L₃ of the third strip conductor pattern 22.

When the distance d between the third strip conductor pattern 22 and each of the first strip conductor pattern 14a and the second strip conductor pattern 14b is in a range in which the coupling degree k, which is a ratio of electromagnetic field coupling, is more than 0 and less than 1 (0<k<1), a first coupled line 22a is configured between the third strip conductor pattern 22 and the first strip conductor pattern 14a, and a second coupled line 22b is configured between the third strip conductor pattern 22 and the second strip conductor pattern 14b.

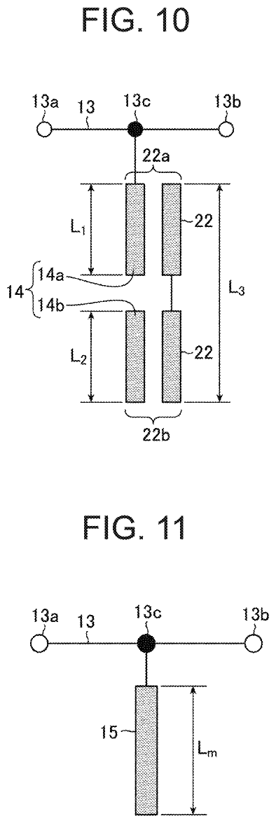

That is, as illustrated in FIG. 10, the stub transmission line connected to the connection portion 13c in the signal conductor pattern 13 is electrically equivalent to a circuit in which a first end of the first coupled line 22a is connected to the connection portion 13c in the signal conductor pattern 13 and a second end of the first coupled line 22a is cascade-connected to a first end of the second coupled line 22b.

Therefore, when the resonance frequency for the high-frequency signal propagating through the stub transmission line formed by the first coupled line 22a and the second coupled line 22b is defined as a third resonance frequency f₀ₘ, the coupling degree k decreases from 1 with increasing the distance from the contact state of the third strip conductor pattern 22 with the first strip conductor pattern 14a and the second strip conductor pattern 14b in the Z direction, that is, the distance d increases, and thus the third resonance frequency f₀ₘ is shifted to the frequency side higher than the first resonance frequency f_{0L}, and an electrical short-circuit point is always formed at the connection portion 13c in the signal conductor pattern 13.

When the distance d is further increased and the coupling degree k approaches 0, the third resonance frequency f₀ₘ is shifted to asymptotically approach the second resonance frequency f_{0H}.

As a result, the stub transmission line formed by the first coupled line 22a and the second coupled line 22b operates as a ¼-wavelength open-ended stub in which an electrical short-circuit point is formed at the connection portion 13c in the signal conductor pattern 13 at the third resonance frequency f₀ₘ.

Therefore, in the signal conductor pattern 13, among the high-frequency signals input from the first input and output terminal 13a, the high-frequency signals at the third resonance frequency f₀ₘ and at frequencies in the vicinity including the third resonance frequency f₀ₘ are attenuated by the ¼-wavelength open-ended stub, and are prevented from passing to the second input and output terminal 13b.

In the first embodiment, the relationship among the first resonance frequency f_{0L}, the second resonance frequency f_{0H}, and the third resonance frequency f₀ₘ is f_{0L}<f₀ₘ<f_{0H}, and f_{0H}=2×f_{0L} is set.

Therefore, the following Equation (1) holds among the first resonance frequency f_{0L}, the second resonance frequency f_{0H}, the third resonance frequency f₀ₘ, and the coupling degree k.

$$\begin{matrix}cosh ( \frac{π}{4} \frac{{f}_{0 m}}{{f}_{0 L}} ) = cosh ( \frac{π}{2} \frac{{f}_{0 m}}{{f}_{0 H}} ) = \frac{k}{\sqrt{2}} & ( 0 ≦ k ≦ 1 )\end{matrix} \qquad ( 1 )$$

In the above Equation (1), when the coupling degree k=1 representing the state of the distance d=0, the third resonance frequency f₀ₘ coincides with the first resonance frequency f_{0L} (f₀ₘ=f_{0L}).

In addition, in the above Equation (1), when the coupling degree k=0 is satisfied, representing a state where the distance d is sufficiently large, the third resonance frequency f₀ₘ coincides with the second resonance frequency f_{0H} (f₀ₘ=f_{0H}).

Furthermore, in the above Equation (1), when the coupling degree k representing a state where the distance d exceeds 0 is 0<k<1, the third resonance frequency f₀ₘ is a frequency between the first resonance frequency f_{0L} and the second resonance frequency f_{0H}.

From the above, in the first embodiment, as illustrated in FIG. 11, it is electrically equivalent to a stub transmission line 15 having an equivalent length Lₘ (L₁≤Lₘ≤L₃) corresponding to the distance d being connected to the connection portion 13c in the signal conductor pattern 13.

The stub transmission line 15 having the length Lₘ operates as a ¼-wavelength open-ended stub in which an electrical short-circuit point is formed at the connection portion 13c in the signal conductor pattern 13 at a selected length Lₘ, that is, a frequency (frequency equal to or more than f_{0L} and equal to or less than f_{0H} (=2×f_{0L})) between the first resonance frequency f_{0L} and the second resonance frequency f_{0H} corresponding to the selected distance d.

That is, by the second substrate 20 being vertically moved with the front face of the first substrate 10 as a reference, the resonance frequency can be changed in the range of the first resonance frequency f_{0L} to the second resonance frequency f_{0H} by the first strip conductor pattern 14a and the second strip conductor pattern 14b, and the third strip conductor pattern 22, whereby it is possible to operate as the ¼-wavelength open-ended stub with respect to the frequency corresponding to the selected distance d.

Therefore, in the signal conductor pattern 13, among the high-frequency signals input from the first input and output terminal 13a, the high-frequency signals at a resonance frequency selected from the range of the first resonance frequency f_{0L} to the second resonance frequency f_{0H} and at frequencies in the vicinity including the selected resonance frequency are attenuated by the ¼-wavelength open-ended stub, and are prevented from passing to the second input and output terminal 13b.

Next, in the variable resonator according to the first embodiment, setting of a frequency at which the passage of the high-frequency signals to be propagated to the signal conductor pattern 13 is blocked will be described.

First, the movable mechanism is operated to obtain the electrical origin as a state in which the third strip conductor pattern 22 is in contact with the first strip conductor pattern 14a and the second strip conductor pattern 14b.

In a case where an actuator such as a voice coil motor or a moving coil actuator is used as the movable mechanism, the driving of the actuator is made free to apply a downward force to the movable plate 30 by the weight of the actuator, and the third strip conductor pattern 22 is brought into contact with the first strip conductor pattern 14a and the second strip conductor pattern 14b.

Next, the movable mechanism is driven to gradually move the movable plate 30 upward, and the distance d between the third strip conductor pattern 22 and each of the first strip conductor pattern 14a and the second strip conductor pattern 14b is gradually increased from 0.

By gradually increasing the distance d from 0, the coupling degree k between the first coupled line 22a and the second coupled line 22b gradually decreases from 1.

As the coupling degree k gradually decreases from 1, the resonance frequency of the ¼-wavelength open-ended stub in which the electrical short circuit point is formed at the connection portion 13c in the signal conductor pattern 13, formed by the first strip conductor pattern 14a and the second strip conductor pattern 14b, and the third strip conductor pattern 22, gradually increases from the first resonance frequency f_{0L}.

When the resonance frequency in the ¼-wavelength open-ended stub reaches the set frequency, the driving of the movable mechanism is stopped, the movement of the movable plate 30 in the upward direction is stopped, and the distance d is fixed.

As a result, it is possible to obtain a resonator in which propagation of a resonance frequency and frequencies in the vicinity including the resonance frequency in the selected ¼-wavelength open-ended stub among the high-frequency signals propagating through the signal conductor pattern 13 is blocked.

The resonance frequency in the ¼-wavelength open-ended stub is obtained from the first resonance frequency f_{0L} up to the second resonance frequency f_{0H}.

Therefore, among the high-frequency signals propagating through the signal conductor pattern 13, the frequency at which propagation is blocked can be set over a wide range from the first resonance frequency f_{0L} to the second resonance frequency f_{0H} (=2×f_{0L}).

As described above, the variable resonator according to the first embodiment includes the first substrate 10 on which the signal conductor pattern 13, the first strip conductor pattern 14a having a first end electrically connected to the signal conductor pattern 13, and the second strip conductor pattern 14b disposed with a spacing from a second end of the first strip conductor pattern 14a are disposed on the front face of the first dielectric substrate 11, the second substrate 20 in which the third strip conductor pattern 22 is disposed on a back face of the second dielectric substrate 21 in such a manner as to face the first strip conductor pattern 14a and the second strip conductor pattern 14b, the movable plate that is connected to the front face of the second substrate 20, is movable in the front and back direction of the second substrate 20, and adjusts a distance between the front face of the first substrate 10 and the back face of the second substrate 20, and thus, by the second substrate 20 being vertically moved with the front face of the first substrate 10 as a reference, the coupling degree k, which is the ratio of electromagnetic field coupling of the first strip conductor pattern 14a and the second strip conductor pattern 14b with the third strip conductor pattern 22, can be changed from 1 to 0, and the frequency for blocking propagation among the high frequency signals propagating through the signal conductor pattern 13 can be set over a wide range from the first resonance frequency f_{0L} when the coupling degree k is 1 to the second resonance frequency f_{0H} when the coupling degree k is 0.

### Second Embodiment

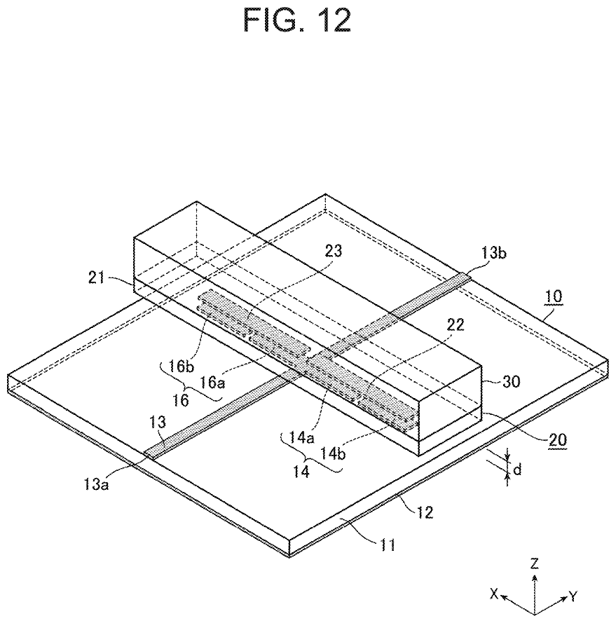

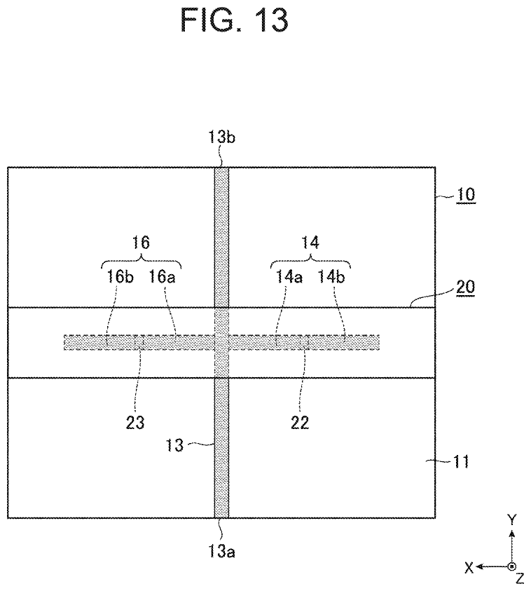

A variable resonator according to a second embodiment will be described with reference to FIGS. 12 to 16.

The variable resonator according to the second embodiment is different from the variable resonator according to the first embodiment in that a second stub conductor pattern 16 that is mirror-image symmetric with the stub conductor pattern 14 with respect to the central axis in the longitudinal direction (Y direction) of the signal conductor pattern 13 is additionally arranged on the front face of the first dielectric substrate 11, and a sixth strip conductor pattern 23 that is a second coupling degree adjusting conductor pattern for adjusting the coupling degree that is a ratio of electromagnetic field coupling with the second stub conductor pattern 16 is additionally arranged on the back face of the second dielectric substrate 21, and the other points are the same.

In FIGS. 12 to 16, the same reference numerals as those attached in FIGS. 1 to 11 denote the same or corresponding parts.

Hereinafter, the second stub conductor pattern 16 and the second coupling degree adjusting conductor pattern 23, which are differences from the variable resonator according to the first embodiment, will be mainly described.

The variable resonator according to the second embodiment includes the first substrate 10, the second substrate 20, and the movable plate 30.

The first substrate 10 includes the dielectric substrate 11, the ground conductor 12, the signal conductor pattern 13, the first stub conductor pattern 14, and a second stub conductor pattern 16.

The second substrate 20 includes the second dielectric substrate 21, the third strip conductor pattern 22 which is a first coupling degree adjusting conductor pattern, and the sixth strip conductor pattern 23 that is a second coupling degree adjusting conductor pattern.

Since the first dielectric substrate 11, the ground conductor 12, the signal conductor pattern 13, and the first stub conductor pattern 14 are the same as the first dielectric substrate 11, the ground conductor 12, the signal conductor pattern 13, and the first stub conductor pattern 14 in the variable resonator according to the first embodiment, the description thereof will be omitted.

In addition, since the second dielectric substrate 21 and the third strip conductor pattern 22 are the same as the second dielectric substrate 21 and the third strip conductor pattern 22 in the variable resonator according to the first embodiment, the description thereof is omitted.

However, in the second embodiment, a width W₁ of the first strip conductor pattern 14a and a width W₁ of the second strip conductor pattern 14b constituting the first stub conductor pattern 14 are narrower than the width W of the signal conductor pattern 13, the width W of the first strip conductor pattern 14a and the width W of the second strip conductor pattern 14b constituting the first stub conductor pattern 14 in the variable resonator according to the first embodiment.

Therefore, in the second embodiment, the area occupied by the connection portion 13c, which is the connection point between the first end of the first strip conductor pattern 14a and the first side face of the signal conductor pattern 13, can be reduced, and the influence of the area occupied by the connection portion 13c on transmission characteristics (frequency characteristics) of the high-frequency signals propagating through the signal conductor pattern 13 is reduced.

Further, a width W₁ of the third strip conductor pattern 22 is narrower than the width W of the third strip conductor pattern 22 in the variable resonator according to the first embodiment.

The widths W₁ of the first strip conductor pattern 14a, the second strip conductor pattern 14b, and the third strip conductor pattern 22 are narrow, and coupled lines between the first strip conductor pattern 14a, the second strip conductor pattern 14b, and the third strip conductor pattern 22 have a high characteristic impedance.

The second stub conductor pattern 16 in the first substrate 10 is disposed on the front face of the first dielectric substrate 11 at a position mirror-image symmetric to the first stub conductor pattern 14 with respect to the central axis in the longitudinal direction (Y direction) of the signal conductor pattern 13.

The second stub conductor pattern 16 includes a fourth strip conductor pattern 16a and a fifth strip conductor pattern 16b.

The fourth strip conductor pattern 16a is a strip line formed on the front face of the first dielectric substrate 11, and constitutes a third stub transmission line together with the ground conductor 12, with the first dielectric substrate 11 interposed therebetween.

The fourth strip conductor pattern 16a is a linear conductor foil having a length L₁, for example, a copper foil.

A first end of the fourth strip conductor pattern 16a is electrically connected to a second side face of the signal conductor pattern 13, and a second end of the fourth strip conductor pattern 16a is an open end.

The fourth strip conductor pattern 16a and the signal conductor pattern 13 are integrally formed conductor foils, the first end of the fourth strip conductor pattern 16a and the second side face of the signal conductor pattern 13 are not physically separated, and a boundary face between the fourth strip conductor pattern 16a and the signal conductor pattern 13 is referred to as the second side face of the signal conductor pattern 13.

The fourth strip conductor pattern 16a is orthogonal to the signal conductor pattern 13 and is disposed on an extension line of the first strip conductor pattern 14a on the front face of the first dielectric substrate 11.

A connection point between the first end of the fourth strip conductor pattern 16a and the second side face of the signal conductor pattern 13 is referred to as a connection portion 13d.

The fifth strip conductor pattern 16b is a strip line formed on the front face of the first dielectric substrate 11, and constitutes a fourth stub transmission line together with the ground conductor 12, with the first dielectric substrate 11 interposed therebetween.

The fifth strip conductor pattern 16b is a linear conductor foil having a length L₂, for example, a copper foil.

Both ends of the fifth strip conductor pattern 16b are open ends, and an open end located at a first end of the fifth strip conductor pattern 16b is disposed with the spacing S from the second end of the fourth strip conductor pattern 16a.

The fifth strip conductor pattern 16b is disposed on an extension line of the fourth strip conductor pattern 16a.

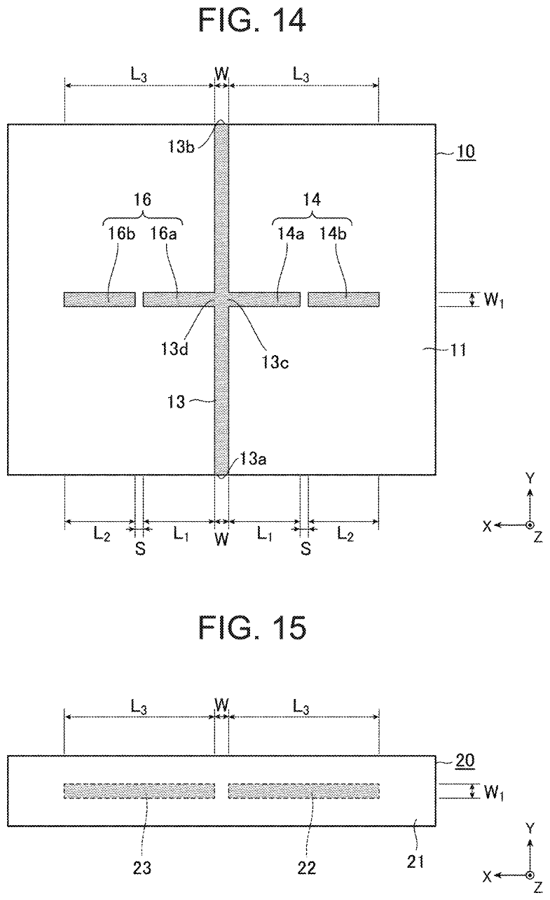

That is, as illustrated in FIG. 14, the fourth strip conductor pattern 16a and the fifth strip conductor pattern 16b are arranged along a straight line in the X direction with the spacing S therebetween on the front face of the first dielectric substrate 11.

The fourth strip conductor pattern 16a and the fifth strip conductor pattern 16b are arranged mirror-image symmetrically with respect to the central axis in the longitudinal direction of the signal conductor pattern 13 via the first strip conductor pattern 14a, the second strip conductor pattern 14b, and the signal conductor pattern 13.

A width W₁ of the fourth strip conductor pattern 16a and a width W₁ of the fifth strip conductor pattern 16b are the same as the width W₁ of the first strip conductor pattern 14a and the width W₁ of the second strip conductor pattern 14b, and are narrower than the width W of the signal conductor pattern 13.

Therefore, the area occupied by the connection portion 13d, which is the connection point between the first end of the fourth strip conductor pattern 16a and a second side portion of the signal conductor pattern 13, can be reduced, and the influence of the area occupied by the connection portion 13d on the transmission characteristics (frequency characteristics) of the high-frequency signals propagating through the signal conductor pattern 13 is reduced.

The sixth strip conductor pattern 23 in the second substrate 20 is disposed on the back face of the second dielectric substrate 21 in such a manner as to face the fourth strip conductor pattern 16a and the fifth strip conductor pattern 16b.

That is, the sixth strip conductor pattern 23 is located immediately above the fourth strip conductor pattern 16a and the fifth strip conductor pattern 16b.

As illustrated in FIG. 15, the sixth strip conductor pattern 23 is disposed at a position mirror-image symmetric to the third strip conductor pattern 22 with respect to the central axis in the longitudinal direction of the signal conductor pattern 13.

The sixth strip conductor pattern 23 is disposed along an extension line of the third strip conductor pattern 22 with a spacing therebetween equal to the width W of the signal conductor pattern 13.

That is, the third strip conductor pattern 22 and the sixth strip conductor pattern 23 are arranged along a straight line in the Y direction with a spacing W therebetween.

The sixth strip conductor pattern 23 is a linear conductor foil having a length L₃, for example, a copper foil.

The length L₃ of the sixth strip conductor pattern 23 is the sum of the length L₁ of the fourth strip conductor pattern 16a, the length L₂ of the fifth strip conductor pattern 16b, and the spacing S between the fourth strip conductor pattern 16a and the fifth strip conductor pattern 16b.

A width W₁ of the sixth strip conductor pattern 23 is equal to the width W₁ of the third strip conductor pattern 22, the width W₁ of the fourth strip conductor pattern 16a, and the width W₁ of the fifth strip conductor pattern 16b.

The sixth strip conductor pattern 23 is a strip conductor parallel to the fourth strip conductor pattern 16a and the fifth strip conductor pattern 16b and, when having a distance d from the fourth strip conductor pattern 16a and the fifth strip conductor pattern 16b with electromagnetic field coupling ranging from tight coupling to loose coupling, forms a coupled line with the fourth strip conductor pattern 16a and the fifth strip conductor pattern 16b.

The widths W₁ of the fourth strip conductor pattern 16a, the fifth strip conductor pattern 16b, and the sixth strip conductor pattern 23 are narrow, and coupled lines between the fourth strip conductor pattern 16a, the fifth strip conductor pattern 16b, and the sixth strip conductor pattern 23 have a high characteristic impedance.

Similarly to the third strip conductor pattern 22, the sixth strip conductor pattern 23 is vertically moved by the second substrate 20 being vertically moved in a range from a contact state (coupling degree k=1) with the fourth strip conductor pattern 16a and the fifth strip conductor pattern 16b to a state sufficiently away from each other (coupling degree k=0).

The propagation wavelengths and the resonance frequencies of the high-frequency signals by the stub transmission line formed by the sixth strip conductor pattern 23, the fourth strip conductor pattern 16a, and the fifth strip conductor pattern 16b by the second substrate 20 being vertically moved with the front face of the first substrate 10 as a reference are the same as the resonance frequencies of the high-frequency signals by the stub transmission line formed by the third strip conductor pattern 22, the first strip conductor pattern 14a, and the second strip conductor pattern 14b.

That is, when the sixth strip conductor pattern 23 is in contact with the fourth strip conductor pattern 16a and the fifth strip conductor pattern 16b (coupling degree k=1), the stub transmission line formed by the sixth strip conductor pattern 23, the fourth strip conductor pattern 16a, and the fifth strip conductor pattern 16b operates as a ¼-wavelength open-ended stub in which an electrical short-circuit point is formed at the connection portion 13d in the signal conductor pattern 13 at the first resonance frequency f_{OL}.

When the coupling degree k=0 is satisfied between the sixth strip conductor pattern 23 and each of the fourth strip conductor pattern 16a and the fifth strip conductor pattern 16b, the stub transmission line formed by the fourth strip conductor pattern 16a operates as a ¼-wavelength open-ended stub in which an electrical short-circuit point is formed at the connection portion 13d in the signal conductor pattern 13 at the second resonance frequency f_{0H}.

When the coupling degree k between the sixth strip conductor pattern 23 and each of the fourth strip conductor pattern 16a and the fifth strip conductor pattern 16b is in a range of more than 0 and less than 1 (0<k<1), a third coupled line is configured between the sixth strip conductor pattern 23 and the fourth strip conductor pattern 16a, and a fourth coupled line is configured between the sixth strip conductor pattern 23 and the fifth strip conductor pattern 16b.

A stub transmission line formed by the third coupled line and the fourth coupled line operates as a ¼-wavelength open-ended stub in which an electrical short-circuit point is formed at the connection portion 13d in the signal conductor pattern 13 at the third resonance frequency f₀ₘ.

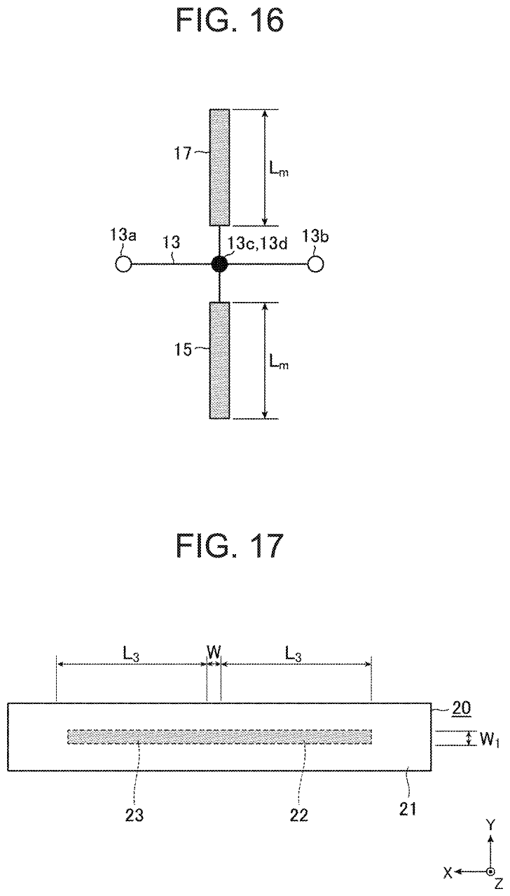

From the above, in the second embodiment, as illustrated in FIG. 16, it is electrically equivalent to the stub transmission line 15 having an equivalent length Lₘ (L₁≤Lₘ≤L₃) corresponding to the distance d being connected to the connection portion 13c in the signal conductor pattern 13, and the stub transmission line 17 having an equivalent length Lₘ (L₁≤Lₘ≤L₃) corresponding to the distance d being connected to the connection portion 13d in the signal conductor pattern 13.

That is, it is electrically equivalent to the configuration in which the ¼-wavelength open-ended stub by the stub transmission line 15 and the ¼-wavelength open-ended stub by the stub transmission line 17, the resonance frequency of which changes depending on the distance d, are connected in parallel, and the stub transmission line 15 and the stub transmission line 17 operate as the ¼-wavelength open-ended stub in which an electrical short-circuit point is formed at the connection portion 13c and the connection portion 13d in the signal conductor pattern 13 at the selected length Lₘ, that is, at the frequency (frequency of f_{0L} or more and f_{0H} (=2×f_{0L}) or less) between the first resonance frequency f_{0L} and the second resonance frequency f_{0H} corresponding to the selected distance d.

In short, the variable resonator according to the second embodiment is a variable resonator in which two variable resonance units, a variable resonance unit A including the first stub conductor pattern 14 and the third strip conductor pattern 22 that is a coupling degree adjusting conductor pattern and a variable resonance unit B including the second stub conductor pattern 16 and the sixth strip conductor pattern 23 that is a coupling degree adjusting conductor pattern, are connected in parallel to the signal conductor pattern 13.

The variable resonance unit A and the variable resonance unit B prevent passage of high-frequency signals having the same frequency among high-frequency signals propagated to the signal conductor pattern 13.

In the variable resonator according to the second embodiment, since the width W₁ of each of the first strip conductor pattern 14a, the second strip conductor pattern 14b, and the third strip conductor pattern 22 and the width W₁ of each of the fourth strip conductor pattern 16a, the fifth strip conductor pattern 16b, and the sixth strip conductor pattern 23 can be narrowed, the impedance from the first coupled line to the fourth coupled line can be increased, and the influence of the area occupying the connection portion 13c and the connection portion 13d in the signal conductor pattern 13 on the transmission characteristics (frequency characteristics) is reduced.

The variable resonator according to the second embodiment has an effect similar to that of the variable resonator according to the first embodiment, and the influence on the transmission characteristics (frequency characteristics) of high-frequency signals propagating through the signal conductor pattern 13 is reduced.

As a result, the variable resonator according to the second embodiment is suitable for use in a millimeter wave band in which a propagation wavelength is short.

Another example 1 of second substrate 20 in variable resonator according to second embodiment A configuration may be employed in which the third strip conductor pattern 22 and the sixth strip conductor pattern 23 in the second substrate 20 are, instead of being arranged along a straight line with the spacing W therebetween, continuously formed with the spacing W filled as illustrated in FIG. 17.

That is, the third strip conductor pattern 22 having a length L₃ and the sixth strip conductor pattern 23 having a length L₃, which are arranged at mirror-image symmetrical positions with respect to the central axis in the longitudinal direction of the signal conductor pattern 13, are continuously formed as one strip conductor pattern having a length (2×L₃+W) on one straight line in the Y direction on the back face of the second dielectric substrate 21.

Another example 2 of second substrate 20 in variable resonator according to second embodiment

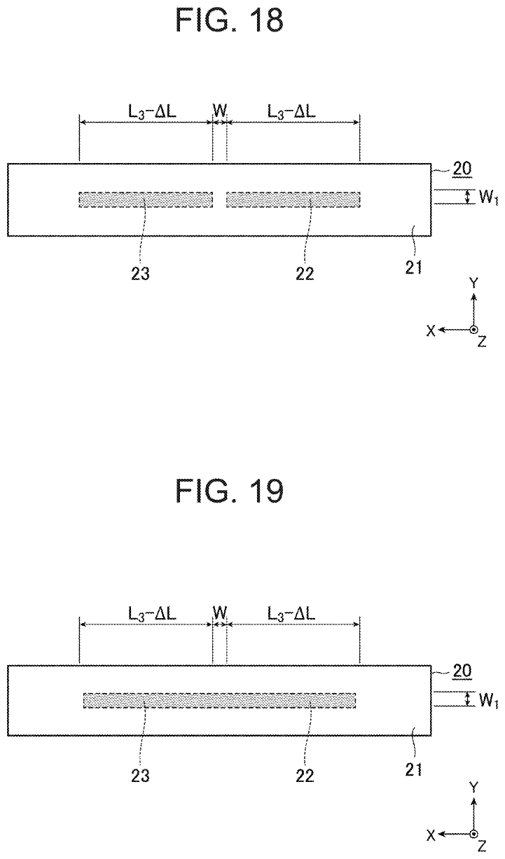

The length of each of the third strip conductor pattern 22 and the sixth strip conductor pattern 23 on the second substrate 20 may be a length L₃′ (=L₃−ΔL) shorter than the length L₃ by ΔL as illustrated in FIG. 18.

The length L₃′ of the third strip conductor pattern 22 is longer than the sum of the length L₁ of the first strip conductor pattern 14a and the spacing S between the first strip conductor pattern 14a and the second strip conductor pattern 14b, and is shorter than the sum of the length L₁ of the first strip conductor pattern 14a, the length L₂ of the second strip conductor pattern 14b, and the spacing S between the first strip conductor pattern 14a and the second strip conductor pattern 14b.

That is, the length L₃′ of the third strip conductor pattern 22 is a length in which the third strip conductor pattern 22 is electrically connected to the first strip conductor pattern 14a and the second strip conductor pattern 14b when the distance d is 0, and when the distance d exceeds 0, the third strip conductor pattern 22 forms the first coupled line 22a with the first strip conductor pattern 14a and forms the first coupled line 22a with the second strip conductor pattern 14b.

The length L₃′ of the sixth strip conductor pattern 23 is longer than the sum of the length L₁ of the fourth strip conductor pattern 16a and the spacing S between the fourth strip conductor pattern 16a and the fifth strip conductor pattern 16b, and is shorter than the sum of the length L₁ of the fourth strip conductor pattern 16a, the length L₂ of the fifth strip conductor pattern 16b, and the spacing S between the fourth strip conductor pattern 16a and the fifth strip conductor pattern 16b.

That is, the length L₃′ of the sixth strip conductor pattern 23 is a length in which the sixth strip conductor pattern 23 is electrically connected to the fourth strip conductor pattern 16a and the fifth strip conductor pattern 16b when the distance d is 0, and when the distance d exceeds 0, the sixth strip conductor pattern 23 forms the first coupled line 22a with the fourth strip conductor pattern 16a and forms the first coupled line 22a with the fifth strip conductor pattern 16b.

That is, L₃′ has a relationship of (L₁+S)<L₃′<(L₁+L₂+S=L₃).

Further, ΔL is a sufficiently shorter range than the propagation wavelength of the fundamental wave in the high-frequency signal, for example, λ/10 or less.

In addition, ΔL only needs to exceed a maximum allowable range of positional deviation in the longitudinal direction (X direction) of the third strip conductor pattern 22 and the sixth strip conductor pattern 23 of the second substrate 20 with respect to the first strip conductor pattern 14a and the fourth strip conductor pattern 16a of the first substrate 10.

By setting ΔL in this manner, the frequency characteristics as the variable resonator are not affected.

Another example 3 of second substrate 20 in variable resonator according to second embodiment

The third strip conductor pattern 22 and the sixth strip conductor pattern 23 in the second substrate 20 may be, instead of being arranged along a straight line with the spacing W therebetween, continuously formed with the spacing W filled as illustrated in FIG. 19, and moreover, the length of each of the third strip conductor pattern 22 and the sixth strip conductor pattern 23 may be a length L₃′ (=L₃−ΔL) that is shorter than the length L₃ by ΔL.

That is, the third strip conductor pattern 22 having a length L₃′ (=L₃−ΔL) and the sixth strip conductor pattern 23 having a length L₃′ (=L₃−ΔL), which are arranged at mirror-image symmetrical positions with respect to the central axis in the longitudinal direction of the signal conductor pattern 13, are continuously formed as one strip conductor pattern having the length (2×L₃′ (=L₃−ΔL)+W) on one straight line in the Y direction on the back face of the second dielectric substrate 21.

### Third Embodiment

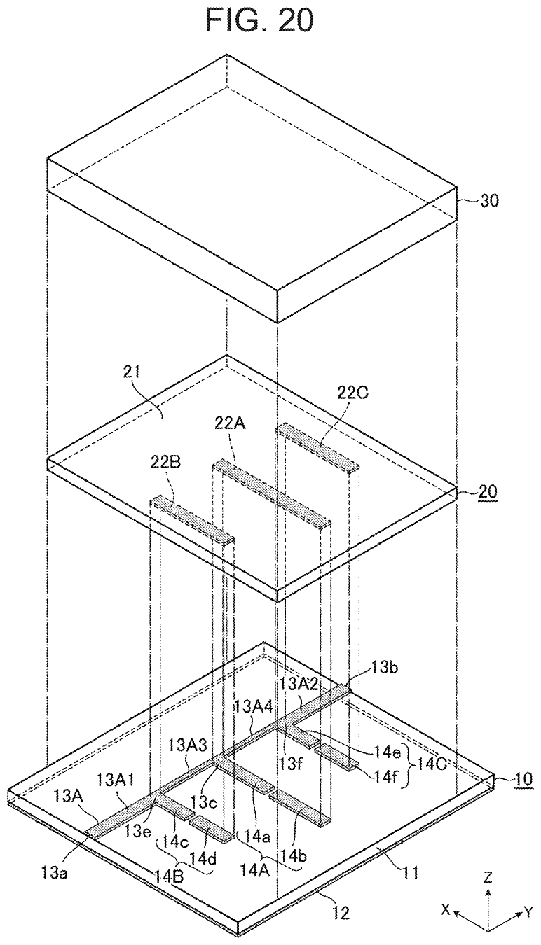

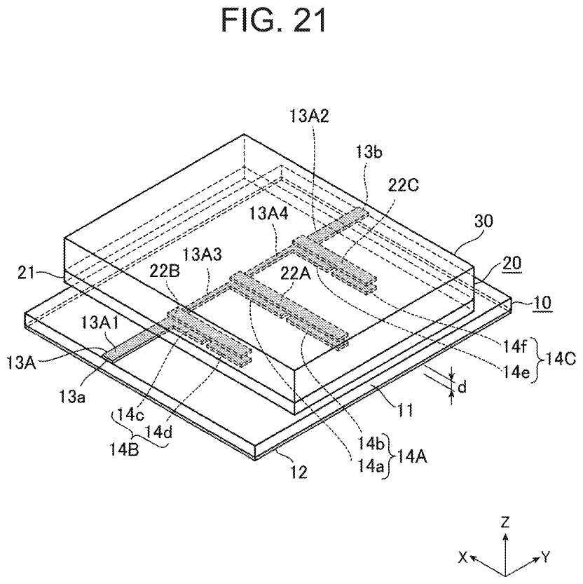

A high-frequency variable filter circuit according to a third embodiment will be described with reference to FIGS. 20 to 32.

The high-frequency variable filter circuit according to the third embodiment includes a first variable resonance unit that prevents passage of a second-order harmonic (second harmonic: frequency f₂=2×f₁) with respect to a fundamental wave (frequency f₁) of a high-frequency signal propagating through a signal conductor pattern 13A, a second variable resonance unit and a third variable resonance unit that prevent passage of a third-order harmonic (third harmonic: frequency f₃=3×f₁).

The high-frequency variable filter circuit according to the third embodiment is, in particular, a high-frequency variable filter circuit used in a communication device in a microwave and millimeter wave communication system, for example, a low-pass filter capable of mechanically adjusting a cutoff frequency and a harmonic to be blocked.

The high-frequency variable filter circuit according to the third embodiment is a low-pass filter configured by a combination of a series inductor and a capacitor.

The high-frequency variable filter circuit according to the third embodiment can adjust the frequency of the fundamental wave from a lower limit frequency f_{1L} to an upper limit frequency f_{1H} with respect to the frequency f₁ of the fundamental wave.

As a result, the high-frequency variable filter circuit according to the third embodiment can adjust the frequency of the second harmonic from the lower limit frequency f_{2L} to the upper limit frequency f_{2H} with respect to the frequency f₂ of the second harmonic, and can adjust the frequency of the third harmonic from a lower limit frequency f_{3L} to an upper limit frequency f_{3H} with respect to the frequency f₃ of the third harmonic.

Further, in the fundamental wave f₁, the upper limit frequency f_{1H} is set to twice the frequency f_{1L} of the lower limit fundamental wave.

As a result, the upper limit frequency f_{2H} is twice the lower limit frequency f_{2L} at the frequency f₂ of the second harmonic, and the upper limit frequency f_{3H} is twice the lower limit frequency f_{3L} at the frequency f₃ of the third harmonic.

In FIGS. 20 to 32, the same reference numerals as those attached in FIGS. 1 to 11 denote the same or corresponding parts.

As illustrated in FIGS. 20 to 27, the high-frequency variable filter circuit according to the third embodiment includes the first substrate 10, the second substrate 20, and the movable plate 30.

The first substrate 10 is a microstrip substrate having a microstrip line for transmitting a high-frequency signal including an electromagnetic wave, and constituting a high frequency filter circuit.

The first substrate 10 includes the first dielectric substrate 11, the ground conductor (ground conductor) 12, the signal conductor pattern 13A, a first stub conductor pattern 14A, a third stub conductor pattern 14B, and a fourth stub conductor pattern 14C.

The first stub conductor pattern 14A functions for setting a cutoff frequency and for setting a resonance frequency for second harmonic prevention in the low-pass filter.

The third stub conductor pattern 14B and the fourth stub conductor pattern 14C each function for setting a cutoff frequency and for setting a resonance frequency for third harmonic prevention in the low-pass filter.

The ground conductor 12 is a conductor foil, for example, a copper foil, formed on the back face of the first dielectric substrate 11 having a planar shape, for example, the entire back face in FIG. 20.

The signal conductor pattern 13A is a microstrip line formed on the front face of the first dielectric substrate 11, and constitutes a signal transmission line together with the ground conductor 12, with the first dielectric substrate 11 interposed therebetween.

The signal conductor pattern 13A includes a first input and output line portion 13A1, a first connection line portion 13A3, a second connection line portion 13A4, and a second input and output line portion 13A2 which are linear conductor foils, for example, copper foils sequentially connected from the first input and output terminal 13a to the second input and output terminal 13b.

A width W₂ of each of the first connection line portion 13A3 and the second connection line portion 13A4 is narrower than the width W of each of the first input and output line portion 13A1 and the second input and output line portion 13A2.

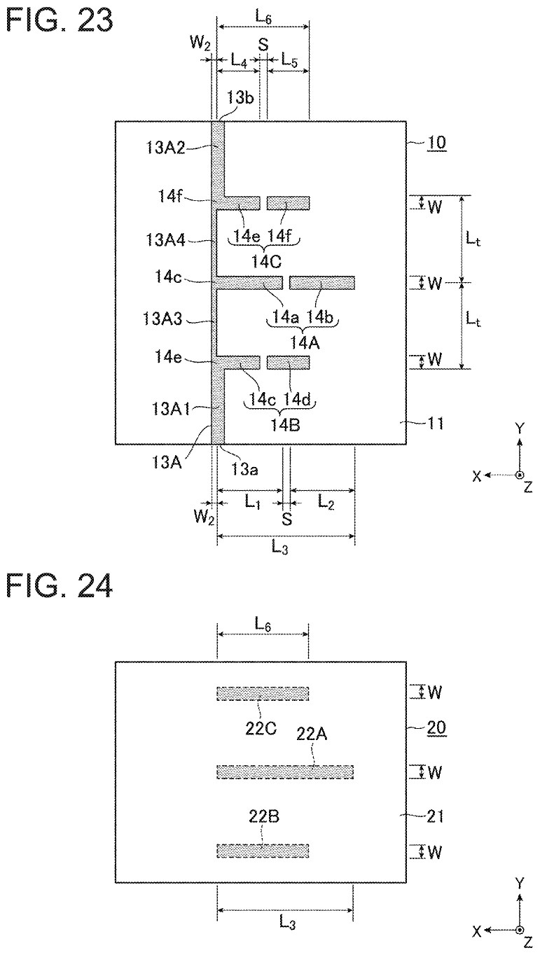

Lengths of the first connection line portion 13A3 and the second connection line portion 13A4 are the same, and are denoted by Lₜ as illustrated in FIG. 23.

Each of the first connection line portion 13A3 and the second connection line portion 13A4 functions as an inductor.

The first stub conductor pattern 14A includes the first strip conductor pattern 14a and the second strip conductor pattern 14b.

Between the first stub conductor pattern 14A and the ground conductor 12, the first stub conductor pattern functions as a first capacitor for the fundamental waves of high-frequency signals propagating through the signal conductor pattern 13A, and functions as a ¼-wavelength open-ended stub for the second harmonic of the fundamental wave.

The first strip conductor pattern 14a is a strip line formed on the front face of the first dielectric substrate 11, and constitutes a first stub transmission line together with the ground conductor 12, with the first dielectric substrate 11 interposed therebetween.

The first strip conductor pattern 14a is a linear conductor foil having a length L₁, for example, a copper foil.

The first end of the first strip conductor pattern 14a is electrically connected to a first side face at a joint portion between a second end of the first connection line portion 13A3 and a first end of the second connection line portion 13A4 of the signal conductor pattern 13A, and the second end of the first strip conductor pattern 14a is an open end.

The first strip conductor pattern 14a, and the first connection line portion 13A3 and the second connection line portion 13A4 of the signal conductor pattern 13A are conductor foils integrally formed, and a first side face at a joint portion between the first end of the first strip conductor pattern 14a and the first connection line portion 13A3 and second connection line portion 13A4 is not physically separated, and a boundary face of the joint portion between the first strip conductor pattern 14a and the first connection line portion 13A3 and second connection line portion 13A4 is referred to as a first side face of the joint portion.

The first strip conductor pattern 14a is disposed on the front face of the first dielectric substrate 11 orthogonal to the first connection line portion 13A3 and the second connection line portion 13A4.

A connection point between the first end of the first strip conductor pattern 14a and a first side portion at the joint portion between the first connection line portion 13A3 and the second connection line portion 13A4 is referred to as the connection portion 13c.

The second strip conductor pattern 14b is a strip line formed on the front face of the first dielectric substrate 11, and constitutes a second stub transmission line together with the ground conductor 12, with the first dielectric substrate 11 interposed therebetween.

The second strip conductor pattern 14b is a linear conductor foil having a length L₂, for example, a copper foil.

Both ends of the second strip conductor pattern 14b are open ends, and an open end located at the first end of the second strip conductor pattern 14b is disposed with the spacing S from the second end of the first strip conductor pattern 14a.

The second strip conductor pattern 14b is disposed on an extension line of the first strip conductor pattern 14a.

That is, as illustrated in FIG. 23, the first strip conductor pattern 14a and the second strip conductor pattern 14b are arranged along a straight line in the X direction with the spacing S therebetween on the front face of the first dielectric substrate 11.

The width W of the first strip conductor pattern 14a and the width W of the second strip conductor pattern 14b are the same.

The width W of the first strip conductor pattern 14a and the width W of the second strip conductor pattern 14b are preferably the same as, or may be different from, the widths W of the first input and output line portion 13A1 and the second input and output line portion 13A2 of the signal conductor pattern 13A.

The third stub conductor pattern 14B includes a seventh strip conductor pattern 14c and an eighth strip conductor pattern 14d.

Between the third stub conductor pattern 14B and the ground conductor 12, the third stub conductor pattern 14B functions as a second capacitor for the fundamental waves of high-frequency signals propagating through the signal conductor pattern 13A, and functions as a ¼-wavelength open-ended stub for third harmonics of the fundamental waves.

The seventh strip conductor pattern 14c is a strip line formed on the front face of the first dielectric substrate 11, and constitutes a fifth stub transmission line together with the ground conductor 12, with the first dielectric substrate 11 interposed therebetween.

The seventh strip conductor pattern 14c is a linear conductor foil having a length L₄, for example, a copper foil.

The length L₄ of the seventh strip conductor pattern 14c is ⅔ of the length L₁ of the first strip conductor pattern 14a.

A first end of the seventh strip conductor pattern 14c is electrically connected to a first side face at a first end portion of the first connection line portion 13A3 of the signal conductor pattern 13A, and a second end of the seventh strip conductor pattern 14c is an open end.

The seventh strip conductor pattern 14c and the first connection line portion 13A3 of the signal conductor pattern 13A are integrally formed conductor foils, and the first end of the seventh strip conductor pattern 14c and the first side face at the first end portion of the first connection line portion 13A3 are not physically separated, and a boundary face between the seventh strip conductor pattern 14c and a first side portion of the first connection line portion 13A3 is referred to as a first side face.

The seventh strip conductor pattern 14c is disposed on the front face of the first dielectric substrate 11 orthogonal to the first connection line portion 13A3.

A connection point between the first end of the seventh strip conductor pattern 14c and the first side portion of the first connection line portion 13A3 is referred to as a connection portion 13e.

The eighth strip conductor pattern 14d is a strip line formed on the front face of the first dielectric substrate 11, and constitutes a sixth stub transmission line together with the ground conductor 12, with the first dielectric substrate 11 interposed therebetween.

The eighth strip conductor pattern 14d is a linear conductor foil having a length L₅, for example, a copper foil.

The length L₅ of the eighth strip conductor pattern 14d is ⅔ of the length L₂ of the second strip conductor pattern 14b.

Both ends of the eighth strip conductor pattern 14d are open ends, and an open end located at a first end of the eighth strip conductor pattern 14d is disposed with the spacing S from the second end of the seventh strip conductor pattern 14c.

The eighth strip conductor pattern 14d is disposed on an extension line of the seventh strip conductor pattern 14c.

That is, as illustrated in FIG. 23, the seventh strip conductor pattern 14c and the eighth strip conductor pattern 14d are arranged along a straight line in the X direction with the spacing S therebetween on the front face of the first dielectric substrate 11.

A width W of the seventh strip conductor pattern 14c and a width W of the eighth strip conductor pattern 14d are the same.

The width W of the seventh strip conductor pattern 14c and the width W of the eighth strip conductor pattern 14d are preferably the same as, or may be different from, the widths W of the first input and output line portion 13A1 and the second input and output line portion 13A2 of the signal conductor pattern 13A.

The fourth stub conductor pattern 14C includes a 10th strip conductor pattern 14e and an 11th strip conductor pattern 14f.

Between the fourth stub conductor pattern 14C and the ground conductor 12, the fourth stub conductor pattern 14C functions as a third capacitor for the fundamental waves of high-frequency signals propagating through the signal conductor pattern 13A, and functions as a ¼-wavelength open-ended stub for a third harmonic of the fundamental wave.

The 10th strip conductor pattern 14e is a strip line formed on the front face of the first dielectric substrate 11, and constitutes a seventh stub transmission line together with the ground conductor 12, with the first dielectric substrate 11 interposed therebetween.

The 10th strip conductor pattern 14e is a linear conductor foil having a length L₄, for example, a copper foil.

The length L₄ of the 10th strip conductor pattern 14e is ⅔ of the length L₁ of the first strip conductor pattern 14a.

A first end of the 10th strip conductor pattern 14e is electrically connected to a first side face at a second end portion of the second connection line portion 13A4 of the signal conductor pattern 13A, and a second end of the 10th strip conductor pattern 14e is an open end.

The 10th strip conductor pattern 14e and the second connection line portion 13A4 of the signal conductor pattern 13A are integrally formed conductor foils, and the first end of the 10th strip conductor pattern 14e and the first side face at the second end portion of the second connection line portion 13A4 are not physically separated, and a boundary face between the 10th strip conductor pattern 14e and a second side portion of the second connection line portion 13A4 is referred to as a first side face.

The 10th strip conductor pattern 14e is disposed on the front face of the first dielectric substrate 11 orthogonal to the second connection line portion 13A4.

A connection point between the first end of the 10th strip conductor pattern 14e and the second side portion of the second connection line portion 13A4 is referred to as a connection portion 13f.

The 11th strip conductor pattern 14f is a strip line formed on the front face of the first dielectric substrate 11, and constitutes an eighth stub transmission line together with the ground conductor 12, with the first dielectric substrate 11 interposed therebetween.

The 11th strip conductor pattern 14f is a linear conductor foil having a length L₅, for example, a copper foil.

The length L₅ of the 11th strip conductor pattern 14f is ⅔ of the length L₂ of the second strip conductor pattern 14b.

Both ends of the 11th strip conductor pattern 14f are open ends, and an open end located at the first end of the 11th strip conductor pattern 14f is disposed with the spacing S from the second end of the 10th strip conductor pattern 14e.

The 11th strip conductor pattern 14f is disposed on an extension line of the 10th strip conductor pattern 14e.

That is, as illustrated in FIG. 23, the 10th strip conductor pattern 14e and the 11th strip conductor pattern 14f are arranged along a straight line in the X direction with the spacing S therebetween on the front face of the first dielectric substrate 11.

A width W of the 10th strip conductor pattern 14e and a width W of the 11th strip conductor pattern 14f are the same.

The width W of the 10th strip conductor pattern 14e and the width W of the 11th strip conductor pattern 14f are preferably the same as, or may be different from, the widths W of the first input and output line portion 13A1 and the second input and output line portion 13A2 of the signal conductor pattern 13A.

The 10th strip conductor pattern 14e and the 11th strip conductor pattern 14f are arranged at positions mirror-image symmetric to the seventh strip conductor pattern 14c and the eighth strip conductor pattern 14d with respect to the central axis in the longitudinal direction (X direction) in the first strip conductor pattern 14a and the second strip conductor pattern 14b.

The second substrate 20 is a coupling degree adjusting substrate that has a first coupling degree adjusting conductor pattern, a third coupling degree adjusting conductor pattern, and a fourth coupling degree adjusting conductor pattern for adjusting a coupling degree k that is a ratio of electromagnetic field coupling with the first stub conductor pattern 14A, the third stub conductor pattern 14B, and the fourth stub conductor pattern 14C in the first substrate 10, and is vertically moved with respect to the first substrate 10.

The second substrate 20 includes a second dielectric substrate 21, a third strip conductor pattern 22A, a ninth strip conductor pattern 22B, and a 12th strip conductor pattern 22C.

The second substrate 20 is disposed in such a manner as to face the first substrate 10, and is vertically moved with respect to the first substrate 10.

The movable plate 30 having a planar shape is connected to the front face of the second substrate 20.

The back face of the second dielectric substrate 21 having a planar shape in the second substrate 20 and the front face of the first dielectric substrate 11 having a planar shape in the first substrate 10 are disposed in such a manner as to face each other, and the second substrate 20 is moved (vertically moved) with the front face of the first substrate 10 as a reference via the movable plate 30 that moves the second substrate 20 in the front and back direction by a movable mechanism (not illustrated).

Note that, in the third embodiment, the second substrate 20 is vertically moved with respect to the first substrate 10, but the first substrate 10 may be vertically moved with the back face of the second substrate 20 as a reference.

The third strip conductor pattern 22A is a first coupling degree adjusting conductor pattern for adjusting a coupling degree k that is a ratio of electromagnetic field coupling with the first stub conductor pattern 14A of the first substrate 10.

The third strip conductor pattern 22A is disposed on the back face of the second dielectric substrate 21 in such a manner as to face the first strip conductor pattern 14a and the second strip conductor pattern 14b.

That is, the third strip conductor pattern 22A is located immediately above the first strip conductor pattern 14a and the second strip conductor pattern 14b.

The third strip conductor pattern 22A is a linear conductor foil having a length L₃, for example, a copper foil.

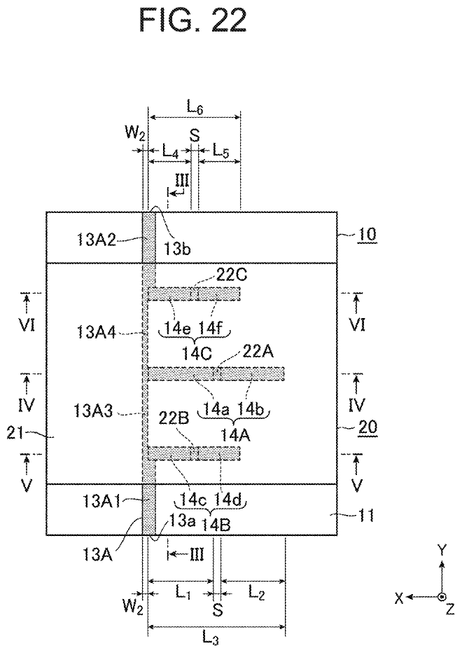

As illustrated in FIGS. 22 and 24, the length L₃ of the third strip conductor pattern 22A is the sum of the length L₁ of the first strip conductor pattern 14a, the length L₂ of the second strip conductor pattern 14b, and the spacing S between the first strip conductor pattern 14a and the second strip conductor pattern 14b.

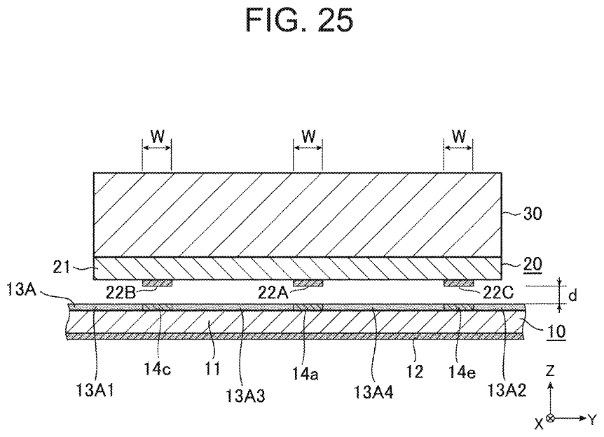

As illustrated in FIG. 25, the width W of the third strip conductor pattern 22A is the same as the width W of the first strip conductor pattern 14a and the width W of the second strip conductor pattern 14b.

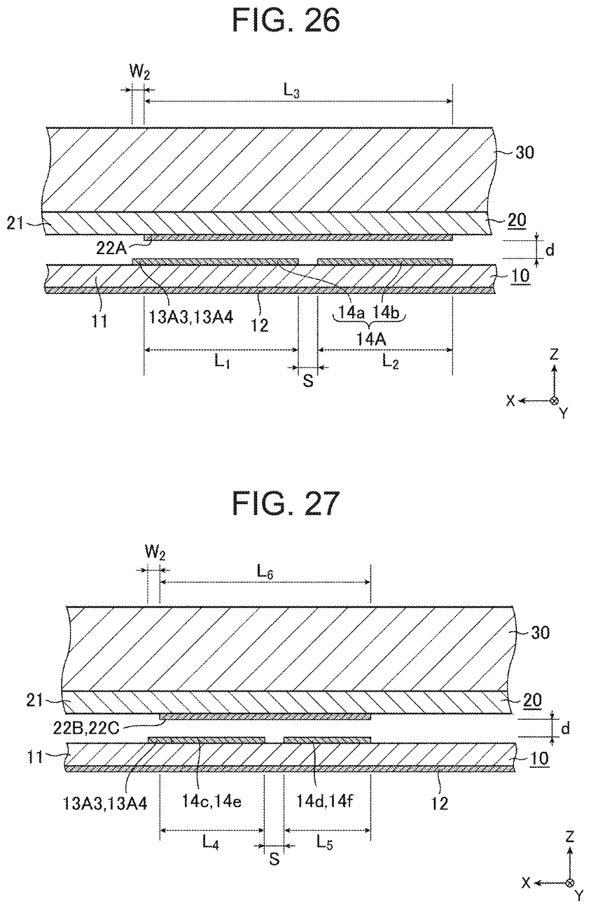

The third strip conductor pattern 22A is a strip conductor parallel to the first strip conductor pattern 14a and the second strip conductor pattern 14b and, when having a distance d (see FIGS. 25 and 26) from the first strip conductor pattern 14a and the second strip conductor pattern 14b with electromagnetic field coupling ranging from tight coupling to loose coupling, forms a coupled line with the first strip conductor pattern 14a and the second strip conductor pattern 14b.

The third strip conductor pattern 22A is vertically moved by the second substrate 20 being vertically moved in a range from a contact state (coupling degree k=1) with the first strip conductor pattern 14a and the second strip conductor pattern 14b to a state sufficiently away from each other (coupling degree k=0).

By the third strip conductor pattern 22A being vertically moved, it is possible to cause the first strip conductor pattern 14a, the second strip conductor pattern 14b, and the third strip conductor pattern 22A to function as a ¼-wavelength open-ended stub in which the frequency for the second harmonics of the fundamental waves in the high-frequency signals propagating through the signal conductor pattern 13A is adjustable from the lower limit frequency f_{2L} to the upper limit frequency f_{2H}.

The upper limit frequency f_{2H} is twice the lower limit frequency f_{2L}, and the length L₃ of the third strip conductor pattern 22A is twice the length L₁ of the first strip conductor pattern 14a.

Further, by the third strip conductor pattern 22A being vertically moved, the resonance frequencies of the high-frequency signals propagating through the first strip conductor pattern 14a and the second strip conductor pattern 14b are adjusted from the lower limit frequency f_{2L} to the upper limit frequency f_{2H}, whereby the capacitance value of the first capacitor between the first stub conductor pattern 14A and the ground conductor 12 can be adjusted from an upper limit capacitance value C_{2H} to a lower limit capacitance value C_{2L}.

The ninth strip conductor pattern 22B is a third coupling degree adjusting conductor pattern for adjusting a coupling degree k that is a ratio of electromagnetic field coupling with the third stub conductor pattern 14B in the first substrate 10.

The ninth strip conductor pattern 22B is disposed on the back face of the second dielectric substrate 21 in such a manner as to face the seventh strip conductor pattern 14c and the eighth strip conductor pattern 14d.

That is, the ninth strip conductor pattern 22B is located immediately above the seventh strip conductor pattern 14c and the eighth strip conductor pattern 14d.

The ninth strip conductor pattern 22B is a linear conductor foil having a length L₆, for example, a copper foil.

As illustrated in FIGS. 22 and 24, the length L₆ of the ninth strip conductor pattern 22B is the sum of the length L₄ of the seventh strip conductor pattern 14c, the length L₅ of the eighth strip conductor pattern 14d, and the spacing S between the seventh strip conductor pattern 14c and the eighth strip conductor pattern 14d.

The length L₆ of the ninth strip conductor pattern 22B is ⅔ of the length L₃ of the third strip conductor pattern 22A.

As illustrated in FIG. 25, the width W of the ninth strip conductor pattern 22B is the same as the width W of the seventh strip conductor pattern 14c and the width W of the eighth strip conductor pattern 14d.

The ninth strip conductor pattern 22B is a strip conductor parallel to the seventh strip conductor pattern 14c and the eighth strip conductor pattern 14d and, when having a distance d (see FIGS. 25 and 27) from the seventh strip conductor pattern 14c and the eighth strip conductor pattern 14d with electromagnetic field coupling ranging from tight coupling to loose coupling, forms a coupled line with the seventh strip conductor pattern 14c and the eighth strip conductor pattern 14d.

The ninth strip conductor pattern 22B is vertically moved by the second substrate 20 being vertically moved in a range from a contact state (coupling degree k=1) with the seventh strip conductor pattern 14c and the eighth strip conductor pattern 14d to a state sufficiently away from each other (coupling degree k=0).

By the ninth strip conductor pattern 22B being vertically moved, it is possible to cause the seventh strip conductor pattern 14c, the eighth strip conductor pattern 14d, and the ninth strip conductor pattern 22B to function as a ¼-wavelength open-ended stub in which the frequency for the third harmonics of the fundamental waves in the high-frequency signals propagating through the signal conductor pattern 13A is adjustable from the lower limit frequency f_{3L} to the upper limit frequency f_{3H}.

The upper limit frequency f_{3H} is twice the lower limit frequency f_{3L}, and the length L₆ of the ninth strip conductor pattern 22B is twice the length L₄ of the seventh strip conductor pattern 14c.

Further, by the ninth strip conductor pattern 22B being vertically moved, the resonance frequencies of the high-frequency signals propagating through the seventh strip conductor pattern 14c and the eighth strip conductor pattern 14d are adjusted from the lower limit frequency f_{3L} to the upper limit frequency f₃H, whereby the capacitance value of the second capacitor between the third stub conductor pattern 14B and the ground conductor 12 can be adjusted from the upper limit capacitance value C_{3H} to the lower limit capacitance value C_{3L}.

The 12th strip conductor pattern 22C is a fourth coupling degree adjusting conductor pattern for adjusting a coupling degree k that is a ratio of electromagnetic field coupling with the fourth stub conductor pattern 14C in the first substrate 10.

The 12th strip conductor pattern 22C is disposed on the back face of the second dielectric substrate 21 in such a manner as to face the 10th strip conductor pattern 14e and the 11th strip conductor pattern 14f.

That is, the 12th strip conductor pattern 22C is located immediately above the 10th strip conductor pattern 14e and the 11th strip conductor pattern 14f.

The 12th strip conductor pattern 22C is a linear conductor foil having a length L₆, for example, a copper foil.

As illustrated in FIGS. 22 and 24, the length L₆ of the 12th strip conductor pattern 22C is the sum of the length L₄ of the 10th strip conductor pattern 14e, the length L₅ of the 11th strip conductor pattern 14f, and the spacing S between the 10th strip conductor pattern 14e and the 11th strip conductor pattern 14f.

The length L₆ of the 12th strip conductor pattern 22C is ⅔ of the length L₃ of the third strip conductor pattern 22A.

As illustrated in FIG. 25, the width W of the 12th strip conductor pattern 22C is the same as the width W of the 10th strip conductor pattern 14e and the width W of the 11th strip conductor pattern 14f.

The 12th strip conductor pattern 22C is a strip conductor parallel to the 10th strip conductor pattern 14e and the 11th strip conductor pattern 14f and, when having a distance d (see FIGS. 25 and 27) from the 10th strip conductor pattern 14e and the 11th strip conductor pattern 14f with electromagnetic field coupling ranging from tight coupling to loose coupling, forms a coupled line with the 10th strip conductor pattern 14e and the 11th strip conductor pattern 14f.

The 12th strip conductor pattern 22C is vertically moved by the second substrate 20 being vertically moved in a range from a contact state (coupling degree k=1) with the 10th strip conductor pattern 14e and the 11th strip conductor pattern 14f to a state sufficiently away from each other (coupling degree k=0).

By the 12th strip conductor pattern 22C being vertically moved, it is possible to cause the 10th strip conductor pattern 14e, the 11th strip conductor pattern 14f, and the 12th strip conductor pattern 22C to function as a ¼-wavelength open-ended stub in which the frequency for the third harmonics of the fundamental waves in the high-frequency signals propagating through the signal conductor pattern 13A is adjustable from the lower limit frequency f_{3L} to the upper limit frequency f_{3H}.

The upper limit frequency f₃H is twice the lower limit frequency f_{3L}, and the length L₆ of the 12th strip conductor pattern 22C is twice the length L₄ of the 10th strip conductor pattern 14e.

By the 12th strip conductor pattern 22C being vertically moved, the resonance frequencies of the high-frequency signals propagating through the 10th strip conductor pattern 14e and the 11th strip conductor pattern 14f are adjusted from the lower limit frequency f_{3L} to the upper limit frequency f_{3H}, whereby the capacitance value of the third capacitor between the fourth stub conductor pattern 14C and the ground conductor 12 can be adjusted from the upper limit capacitance value C_{3H} to the lower limit capacitance value C_{3L}.

Next, the length L₁ of the first strip conductor pattern 14a, the length L₂ of the second strip conductor pattern 14b, and the length L₃ of the third strip conductor pattern 22A will be described.

When the third strip conductor pattern 22A is in contact with the first strip conductor pattern 14a and the second strip conductor pattern 14b, that is, when the distance d=0 is satisfied and the coupling degree k=1, which is the ratio of electromagnetic field coupling, is satisfied, the third strip conductor pattern 22A, the first strip conductor pattern 14a, and the second strip conductor pattern 14b are in an electrical conduction state, and thus it is equivalent to the stub conductor pattern having the length L₃ being electrically connected to the connection portion 13c in the signal conductor pattern 13A.

The length L₃ of the third strip conductor pattern 22A is set to be ¼ of the propagation wavelength at the frequency f_{2L} that is twice the lower limit frequency f_{1L} of the fundamental wave f₁ in such a manner that the frequency f_{2L} that is twice the lower limit frequency f_{1L} (=2×f_{1L}) of the fundamental wave f₁ in the high-frequency signal propagating through the signal conductor pattern 13A, that is, the lower limit frequency f_{2L} with respect to the frequency f₂ of the second harmonic becomes the first resonance frequency.

As a result, the stub transmission line formed by the third strip conductor pattern 22A, the first strip conductor pattern 14a, and the second strip conductor pattern 14b operates as a ¼-wavelength open-ended stub in which an electrical short-circuit point is formed in the connection portion 13c of the signal conductor pattern 13A at the lower limit frequency f_{2L} for the second harmonic of the fundamental wave.

Therefore, in the signal conductor pattern 13A, the high-frequency signals at the lower limit frequency f_{2L} for the second harmonic of the fundamental wave and at frequencies in the vicinity including the lower limit frequency f_{2L} for the second harmonic in the high-frequency signals input from the first input and output terminal 13a are attenuated by the ¼-wavelength open-ended stub based on the stub transmission line formed by the third strip conductor pattern 22A, the first strip conductor pattern 14a, and the second strip conductor pattern 14b, and are prevented from passing to the second input and output terminal 13b.

Similarly, the high-frequency signals at the lower limit frequency f_{2L} for the second harmonic of the fundamental wave and at frequencies in the vicinity including the lower limit frequency f_{2L} for the second harmonic, in the high-frequency signals input from the second input and output terminal 13b are attenuated by the ¼-wavelength open-ended stub based on the stub transmission line formed by the third strip conductor pattern 22A, the first strip conductor pattern 14a, and the second strip conductor pattern 14b, and are prevented from passing to the second input and output terminal 13b.

In addition, the capacitance value of the first capacitor between the first strip conductor pattern 14a and second strip conductor pattern 14b and the ground conductor 12 is the upper limit capacitance value C_{2H} associated with the lower limit frequency f_{2L} for the second harmonic of the fundamental wave.

When the distance d between the third strip conductor pattern 22A and each of the first strip conductor pattern 14a and the second strip conductor pattern 14b is sufficiently large and the coupling degree k=0, which is the ratio of electromagnetic field coupling, is satisfied, the first strip conductor pattern 14a and the second strip conductor pattern 14b are not affected by the third strip conductor pattern 22A, and thus it is electrically equivalent to the first strip conductor pattern 14a having the length L₁ being connected to the connection portion 13c in the signal conductor pattern 13 as the stub conductor pattern.

The length L₁ of the first strip conductor pattern 14a is set to be ¼ of the propagation wavelength at the frequency f_{2H} that is twice the upper limit frequency f_{1H} of the fundamental wave f₁ in such a manner that the frequency f₂H that is twice the upper limit frequency f_{1H} (=2×f_{1H}) of the fundamental wave f₁ in the high-frequency signal propagating through the signal conductor pattern 13A, that is, the upper limit frequency f₂H with respect to the frequency f₂ of the second harmonic of the fundamental wave becomes the second resonance frequency.

As a result, the stub transmission line formed by the first strip conductor pattern 14a operates as a ¼-wavelength open-ended stub in which an electrical short-circuit point is formed in the connection portion 13c of the signal conductor pattern 13A at the upper limit frequency f₂H for the second harmonic of the fundamental wave.

Therefore, in the signal conductor pattern 13A, the high-frequency signals at the upper limit frequency f_{2H} for the second harmonic of the fundamental wave and at frequencies in the vicinity including the upper limit frequency f₂H for the second harmonic, in the high-frequency signals input from the first input and output terminal 13a are attenuated by the ¼-wavelength open-ended stub based on the stub transmission line formed by the first strip conductor pattern 14a, and are prevented from passing to the second input and output terminal 13b.

Similarly, the high-frequency signals at the upper limit frequency f₂H for the second harmonic of the fundamental wave and at frequencies in the vicinity including the upper limit frequency f₂H for the second harmonic, in the high-frequency signals input from the second input and output terminal 13b are attenuated by the ¼-wavelength open-ended stub based on the stub transmission line formed by the first strip conductor pattern 14a, and are prevented from passing to the second input and output terminal 13b.

In addition, the capacitance value of the first capacitor between the first strip conductor pattern 14a and the second strip conductor pattern 14b and the ground conductor 12 is the lower limit capacitance value C_{2L} associated with the upper limit frequency f₂H for the second harmonic of the fundamental wave.

The upper limit frequency f₂H for the second harmonic of the fundamental wave is set to a frequency (f_{2H}=2×f_{2L}) that is twice the lower limit frequency f_{2L} for the second harmonic, and the length L₃ of the third strip conductor pattern 22A is set to a length (L₃≈2×L₁) that is about twice the length L₁ of the first strip conductor pattern 14a.

The length L₂ of the second strip conductor pattern 14b is set to a length (L₂≈L₃−L₁−S) obtained by subtracting the sum of the length L₁ of the first strip conductor pattern 14a and the spacing S between the second end of the first strip conductor pattern 14a and the first end of the second strip conductor pattern 14b from the length L₃ of the third strip conductor pattern 22A.

When the distance d between the third strip conductor pattern 22A and each of the first strip conductor pattern 14a and the second strip conductor pattern 14b is in a range in which the coupling degree k, which is a ratio of electromagnetic field coupling, is more than 0 and less than 1 (0<k<1), a first coupled line 22Aa is configured between the third strip conductor pattern 22A and the first strip conductor pattern 14a, and a second coupled line 22Ab is configured between the third strip conductor pattern 22A and the second strip conductor pattern 14b.

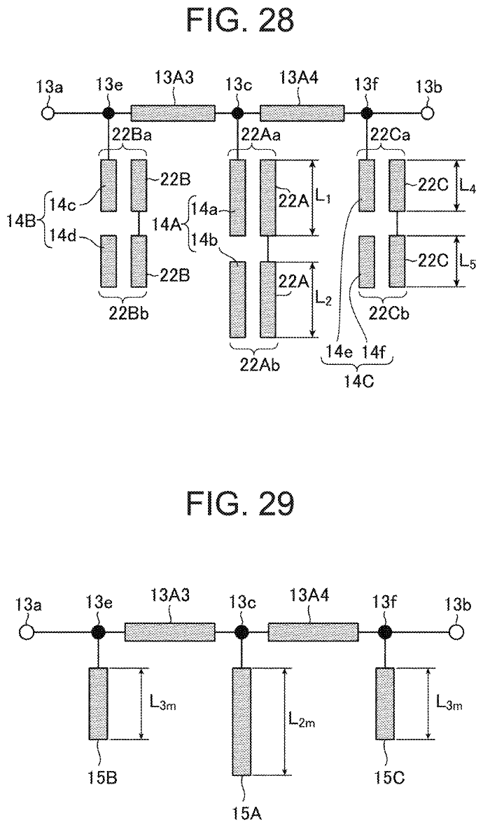

That is, as illustrated in FIG. 28, the stub transmission line connected to the connection portion 13c in the signal conductor pattern 13 is electrically equivalent to a circuit in which a first end of the first coupled line 22Aa is connected to the connection portion 13c in the signal conductor pattern 13A and a second end of the first coupled line 22Aa is cascade-connected to a first end of the second coupled line 22Ab.

Therefore, when an intermediate frequency f₂ₘ with respect to the high-frequency signal having the frequency f₂ of the second harmonic of the fundamental wave propagating through the stub transmission line formed by the first coupled line 22Aa and the second coupled line 22Ab is the third resonance frequency, the coupling degree k decreases from 1 as the distance d increases in the Z direction from the contact state of the third strip conductor pattern 22A with the first strip conductor pattern 14a and the second strip conductor pattern 14b, and thus, the intermediate frequency f₂ₘ is shifted to the frequency side higher than the lower limit frequency f_{2L}, and an electrical short-circuit point is always formed in the connection portion 13c in the signal conductor pattern 13A.

When the distance d is further increased and the coupling degree k approaches 0, the intermediate frequency f₂ₘ is shifted to asymptotically approach the upper limit frequency f_{2H}.

As a result, the stub transmission line formed by the first coupled line 22a and the second coupled line 22b operates as a ¼-wavelength open-ended stub in which an electrical short-circuit point is formed in the connection portion 13c of the signal conductor pattern 13A at the intermediate frequency f₂ₘ.

That is, by the second substrate 20 being vertically moved with the front face of the first substrate 10 as a reference, the resonance frequency can be changed in the range from the lower limit frequency f_{2L} to the upper limit frequency f₂H by the first strip conductor pattern 14a and second strip conductor pattern 14b, and the third strip conductor pattern 22A, whereby it is possible to operate as the ¼-wavelength open-ended stub with respect to the frequency corresponding to the selected distance d.

Therefore, in the signal conductor pattern 13A, the high-frequency signals at the intermediate frequency f₂ₘ for the second harmonics of the fundamental waves and at frequencies in the vicinity including the intermediate frequency f₂ₘ, in the high-frequency signals input from the first input and output terminal 13a are attenuated by the ¼-wavelength open-ended stub based on the stub transmission line formed by the third strip conductor pattern 22A, the first strip conductor pattern 14a, and the second strip conductor pattern 14b, and are prevented from passing to the second input and output terminal 13b.

Similarly, in the signal conductor pattern 13A, the high-frequency signals at the intermediate frequency f₂ₘ for the second harmonics of the fundamental waves and at frequencies in the vicinity including the intermediate frequency f₂ₘ, in the high-frequency signals input from the second input and output terminal 13b are attenuated by the ¼-wavelength open-ended stub based on the stub transmission line formed by the third strip conductor pattern 22A, the first strip conductor pattern 14a, and the second strip conductor pattern 14b, and are prevented from passing to the first input and output terminal 13a.

In the third embodiment, the relationship between the lower limit frequency f_{2L}, the upper limit frequency f_{2H}, and the intermediate frequency f₂ₘ is f_{2L}<f₂ₘ<f_{2H}, and is set to f_{2H}=2×f_{2L}.

In addition, the capacitance value of the first capacitor between the first strip conductor pattern 14a and the second strip conductor pattern 14b and the ground conductor 12 is an intermediate capacitance value C₂ₘ associated with an intermediate frequency f₂ₘ with respect to the second harmonic of the fundamental wave.

In the third embodiment, the lower limit capacitance value C_{2L}, the upper limit capacitance value C_{2H}, and the intermediate capacitance value C₂ₘ have a relationship of C_{2L}<C₂ₘ<C_{2H}.

From the above, in the third embodiment, as illustrated in FIG. 29, it is electrically equivalent to the stub transmission line 15A having an equivalent length L₂ₘ (L₁<L₂ₘ<L₃) corresponding to the distance d and capable of adjusting the resonance frequency from the lower limit frequency f_{2L} to the upper limit frequency f_{2H} for the frequency f₂ of the second harmonic of the fundamental wave being connected to the connection portion 13c in the signal conductor pattern 13A.

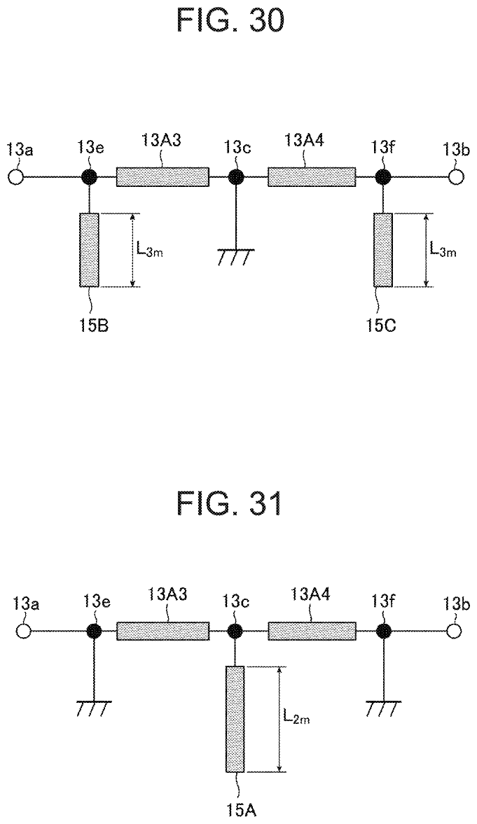

The stub transmission line 15A having the length L₂ₘ operates as a ¼-wavelength open-ended stub in which an electrical short-circuit point is formed in the connection portion 13c of the signal conductor pattern 13A as illustrated in FIG. 30 at a selected length L₂ₘ, that is, a frequency (frequency of f_{2L} or more and f_{2H} (=2×f_{2L}) or less) between the lower limit frequency f_{2L} and the upper limit frequency f₂H corresponding to the distance d selected by the vertical movement of the second substrate 20.

In addition, the stub transmission line 15A having the length L₂ₘ is selected as a capacitance value (a capacitance value of C_{2L} or more and C_{2H} or less) from the upper limit capacitance value C₂H to the lower limit capacitance value C_{2L} corresponding to the selected length L₂ₘ, that is, the distance d selected by the vertical movement of the second substrate 20.

The length L₄ of the seventh strip conductor pattern 14c, the length L₅ of the eighth strip conductor pattern 14d, the length L₆ of the ninth strip conductor pattern 22B, the length L₄ of the 10th strip conductor pattern 14e, the length L₅ of the 11th strip conductor pattern 14f, and the length L₆ of the 12th strip conductor pattern 22C will be described.

The length L₄ is set to ⅔ of the length L₁, the length L₆ is set to ⅔ of the length L₃, and the length L₅ is set to ⅔ of the length L₂.

Therefore, the stub transmission line based on the seventh strip conductor pattern 14c, the eighth strip conductor pattern 14d, and the ninth strip conductor pattern 22B connected to the connection portion 13e in the signal conductor pattern 13A operates as a ¼-wavelength open-ended stub in which an electrical short-circuit point is formed in the connection portion 13e in the signal conductor pattern 13A at the frequency f₃ of the third harmonic of the fundamental wave in the high-frequency signals propagating through the signal conductor pattern 13A.

In addition, the stub transmission line based on the 10th strip conductor pattern 14e, the 11th strip conductor pattern 14f, and the 12th strip conductor pattern 22C, which is connected to the connection portion 13f in the signal conductor pattern 13A, operates as a ¼-wavelength open-ended stub in which an electrical short-circuit point is formed in the connection portion 13f in the signal conductor pattern 13A at the frequency f₃ of the third harmonic of the fundamental wave in the high-frequency signals propagating through the signal conductor pattern 13A.

The stub transmission line connected to the connection portion 13e in the signal conductor pattern 13A is electrically equivalent to a circuit in which, as illustrated in FIG. 28, a first end of a fifth coupled line 22Ba is connected to the connection portion 13e in the signal conductor pattern 13A and a second end of a sixth coupled line 22Bb is cascade-connected to the first end of the fifth coupled line 22Ba, and is electrically equivalent to, as illustrated in FIG. 29, the stub transmission line 15B having an equivalent length L₃ₘ (L₄≤L₃ₘ≤L₆) corresponding to the distance d and capable of adjusting the resonance frequency from the lower limit frequency f_{3L} to the upper limit frequency f₃H for the frequency f₃ of the third harmonic of the fundamental wave being connected to the connection portion 13e in the signal conductor pattern 13A.

In addition, the stub transmission line connected to the connection portion 13f in the signal conductor pattern 13A is electrically equivalent to a circuit in which, as illustrated in FIG. 28, a first end of a seventh coupled line 22Ca is connected to the connection portion 13f in the signal conductor pattern 13A and a second end of an eighth coupled line 22Cb is cascade-connected to the first end of the seventh coupled line 22Ca, and is electrically equivalent to, as illustrated in FIG. 29, the stub transmission line 15C having an equivalent length L₃ₘ (L₄≤L₃ₘ≤L₆) corresponding to the distance d and capable of adjusting the resonance frequency from the lower limit frequency f_{3L} to the upper limit frequency f_{3H} for the frequency f₃ of the third harmonic of the fundamental wave being connected to the connection portion 13e in the signal conductor pattern 13A.

Each of the stub transmission line 15B having the length L₃ₘ and the stub transmission line 15C having the length L₃ₘ operates as a ¼-wavelength open-ended stub in which, as illustrated in FIG. 31, an electrical short-circuit point is formed in each of the connection portion 13e and the connection portion 13f in the signal conductor pattern 13A, at frequencies (frequencies of f_{3L} or more and f_{3H} (=2×f_{3L}) or less) between the lower limit frequency f_{3L} and the upper limit frequency f_{3H} corresponding to the selected length L₃ₘ, that is, the distance d selected by the vertical movement of the second substrate 20.

Therefore, in the signal conductor pattern 13A, a high-frequency signal at a frequency (selected from frequencies of f_{3L} or more and f_{3H} or less) for the third harmonic of the fundamental wave in the high-frequency signals input from the first input and output terminal 13a is attenuated by the ¼-wavelength open-ended stub based on the stub transmission line formed by the seventh strip conductor pattern 14c and the eighth strip conductor pattern 14d, and the ninth strip conductor pattern 22B, and is prevented from passing to the second input and output terminal 13b.

In addition, in the signal conductor pattern 13A, a high-frequency signal at a frequency (selected from frequencies of f_{3L} or more and f_{3H} or less) for the third harmonic of the fundamental wave in the high-frequency signals input from the second input and output terminal 13b is attenuated by the ¼-wavelength open-ended stub based on the stub transmission line formed by the 10th strip conductor pattern 14e, the 11th strip conductor pattern 14f, and the 12th strip conductor pattern 22C, and is prevented from passing to the first input and output terminal 13a.

On the other hand, each of the stub transmission line 15B having the length L₃ₘ and the stub transmission line 15 having the length L₃ₘ is selected as a capacitance value (capacitance value of C_{3L} or more and C_{3H} or less) from the upper limit capacitance value C_{3H} to the lower limit capacitance value C_{3L} corresponding to the selected length L₃ₘ, that is, the distance d selected by the vertical movement of the second substrate 20.

With the distance d selected by the vertical movement of the second substrate 20, the capacitance value by each of the stub transmission line 15B having the length L₃ₘ and the stub transmission line 15 having the length L₃ₘ is smaller than the capacitance value by the stub transmission line 15A having the length L₂ₘ.

In short, in the third embodiment, by the third strip conductor pattern 22A being vertically moved, the resonance frequency for the second harmonic of the frequency f₂ of the high-frequency signal propagating through the signal conductor pattern 13A is adjusted to a frequency between the lower limit frequency f_{2L} and the upper limit frequency f_{2H}.

Each of the ninth strip conductor pattern 22B and the 12th strip conductor pattern 22C is vertically moved to adjust the resonance frequency for the third harmonic of the frequency f₃ in the high-frequency signal propagating through the signal conductor pattern 13A to a frequency between the lower limit frequency f_{3L} and the upper limit frequency f_{3H}.

As a result, the variable frequency range that can be mechanically adjusted with respect to the frequencies of the second harmonics and the third harmonics of the fundamental waves in the high-frequency signals propagating between the first input and output terminal 13a and the second input and output terminal 13b is wide, and the passage of the second harmonic and the third harmonic of the fundamental wave can be prevented with high accuracy.

On the other hand, in the third embodiment, by the third strip conductor pattern 22A being vertically moved with respect to the fundamental waves of the high-frequency signals propagating between the first input and output terminal 13a and the second input and output terminal 13b, the capacitance value of the first capacitor between the first stub conductor pattern 14A and the ground conductor 12 is adjusted to a capacitance value from the upper limit capacitance value C_{2H} to the lower limit capacitance value C_{2L}.

By the ninth strip conductor pattern 22B being vertically moved with respect to the fundamental waves of the high-frequency signals propagating between the first input and output terminal 13a and the second input and output terminal 13b, the capacitance value of the second capacitor between the third stub conductor pattern 14B and the ground conductor 12 is adjusted to a capacitance value from the upper limit capacitance value C_{3H} to the lower limit capacitance value C_{3L}.

By the 12th strip conductor pattern 22C being vertically moved with respect to the fundamental waves of the high-frequency signals propagating between the first input and output terminal 13a and the second input and output terminal 13b, the capacitance value of the third capacitor between the fourth stub conductor pattern 14C and the ground conductor 12 is adjusted to a capacitance value from the upper limit capacitance value C_{3H} to the lower limit capacitance value C_{3L}.

That is, by the third strip conductor pattern 22A, the ninth strip conductor pattern 22B, and the 12th strip conductor pattern 22C being vertically moved simultaneously, the capacitance values of the first capacitor to the third capacitor with respect to the fundamental wave of the frequency f₁ of the high-frequency signal propagating through the signal conductor pattern 13A can be adjusted.

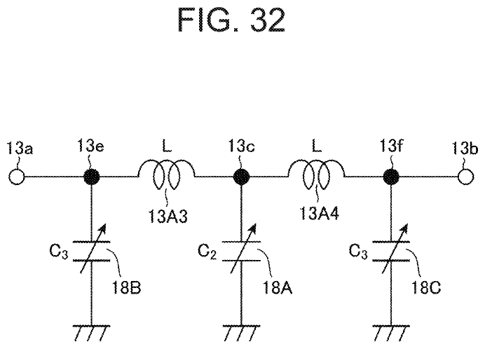

For the fundamental waves of the high-frequency signals propagating through the signal conductor pattern 13A, as illustrated in FIG. 32, a low-pass filter is configured by an L-C circuit including two inductors connected in series between the connection portion 13e and the connection portion 13f by the first connection line portion 13A3 and the second connection line portion 13A4, a first capacitor 18A of a variable capacitance C₂ including a first stub conductor pattern 14A connected to the connection portion 13c, a second capacitor 18B of a variable capacitance C₃ including a third stub conductor pattern 14B connected to the connection portion 13e, and a third capacitor 18C of a variable capacitance C₃ including a fourth stub conductor pattern 14C connected to the connection portion 13f.

In the low-pass filter configured as described above, with respect to the frequencies of the fundamental waves of the high-frequency signals propagated between the first input and output terminal 13a and the second input and output terminal 13b in the signal conductor pattern 13A, since the frequencies can be mechanically adjusted to frequencies between the lower limit frequency f_{1L} and the upper limit frequency f_{1H} corresponding to the distance d selected by the vertical movement of the second substrate 20, the variable frequency range is wide with respect to the frequencies of the fundamental waves, and the cutoff frequency of the low-pass filter can be adjusted with high accuracy in the range from the lower limit frequency f_{1L} to the upper limit frequency f_{1H}.

As described above, the high-frequency variable filter circuit according to the third embodiment includes: the first substrate 10 including, on the front face of the first dielectric substrate 11, the signal conductor pattern 13A having the first input and output line portion 13A1, the first connection line portion 13A3, the second connection line portion 13A4, and the second input and output line portion 13A2 sequentially connected, the first strip conductor pattern 14a electrically connected to the connection portion 13c between a second end of the first connection line portion 13A3 and a first end of the second connection line portion 13A4, the second strip conductor pattern 14b disposed with a spacing from the second end of the first strip conductor pattern 14a, the seventh strip conductor pattern 14c electrically connected to the connection portion 13e having a first end that is a first end portion of the first connection line portion 13A3, the eighth strip conductor pattern 14d disposed at a distance from a second end of the seventh strip conductor pattern 14c, the 10th strip conductor pattern 14e electrically connected to the connection portion 13f having a first end that is a second end portion of the second connection line portion 14A4, and the 11th strip conductor pattern 14f disposed with a spacing from the second end of the 10th strip conductor pattern 14e; and the second substrate 20 including, on a back face of the second dielectric substrate 21, the third strip conductor pattern 22A disposed in such a manner as to face the first strip conductor pattern 14a and the second strip conductor pattern 14b, the ninth strip conductor pattern 22B disposed in such a manner as to face the seventh strip conductor pattern 14c and the eighth strip conductor pattern 14d, the 12th strip conductor pattern 22C disposed in such a manner as to face the 10th strip conductor pattern 14e and the 11th strip conductor pattern 14f, and the movable plate connected to a front face of the second substrate 20, movable in a front and back direction of the second substrate 20, and configured to adjust a distance between a front face of the first substrate 10 and a back face of the second substrate 20, in which the variable capacitance C₂ in the first capacitor 18A configured by the first stub conductor pattern 14A based on the first strip conductor pattern 14a connected to the connection portion 13c and the second strip conductor pattern 14b, the variable capacitance C₃ based on the second capacitor 18B configured by the third stub conductor pattern 14B based on the seventh strip conductor pattern 14c connected to the connection portion 13e and the eighth strip conductor pattern 14d, the variable capacitance C₃ of the third capacitor 18C configured by the fourth stub conductor pattern 14C based on the 10th strip conductor pattern 14e connected to the connection portion 13f and the 11th strip conductor pattern 14f can be mechanically adjusted from the upper limit capacitance values C₂H and C₃H to the lower limit capacitance values C_{2L} and C_{3L} by the second substrate 20 being vertically moved with the front face of the first substrate 10 as a reference, and as a result, since the frequency f₁ of the fundamental wave propagating through the signal conductor pattern 13A can be mechanically adjusted from the lower limit frequency f_{1L} to the upper limit frequency f_{1H}, the variable frequency range is wide with respect to the frequency of the fundamental wave, and the cutoff frequency of the low-pass filter can be accurately adjusted in the range from the lower limit frequency f_{1L} to the upper limit frequency f_{1H}.

In the high-frequency variable filter circuit according to the third embodiment, since the upper limit frequency f_{1H} is set to twice the lower limit frequency f_{1L} as the variable frequency range with respect to the frequency f₁ of the fundamental wave, the frequency f₁ of the fundamental wave can be mechanically set over a wide range of 50% in terms of a ratio.

Furthermore, the high-frequency variable filter circuit according to the third embodiment can change the coupling degree k, which is the ratio of the electromagnetic field coupling between the first strip conductor pattern 14a and the second strip conductor pattern 14b, and the third strip conductor pattern 22A, the coupling degree k, which is the ratio of the electromagnetic field coupling between the seventh strip conductor pattern 14c and the eighth strip conductor pattern 14d, and the ninth strip conductor pattern 22B, and the coupling degree k, which is the ratio of the electromagnetic field coupling between the 10th strip conductor pattern 14e and the 11th strip conductor pattern 14f, and the 12th strip conductor pattern 22C, from 1 to 0 by the second substrate 20 being vertically moved with the front face of the first substrate 10 as a reference, so that as a result of mechanically adjusting the resonance frequency over a wide range from the resonance frequencies f_{2L} and f_{3L} when the coupling degree k is 1 to the resonance frequencies f_{2H} and f_{3H} when the coupling degree k is 0, the variable frequency range that can be mechanically adjusted with respect to the frequencies of the second harmonic and the third harmonics of the fundamental waves is wide, and the passage of the second harmonics and the third harmonics of the fundamental waves can be prevented with high accuracy according to the frequency of the selected fundamental wave.

### Fourth Embodiment

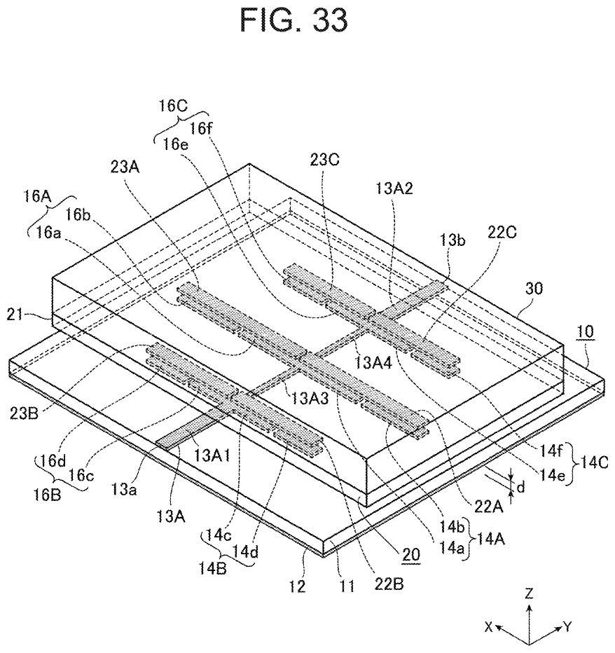

A high-frequency variable filter circuit according to a fourth embodiment will be described with reference to FIGS. 33 to 35.

The high-frequency variable filter circuit according to the fourth embodiment is different from the high-frequency variable filter circuit according to the third embodiment in that each of the following is provided: a second stub conductor pattern 16A that is mirror-image symmetric with the first stub conductor pattern 14A, a fifth stub conductor pattern 16B that is mirror-image symmetric with the third stub conductor pattern 14B, and a sixth stub conductor pattern 16C that is mirror-image symmetric with the fourth stub conductor pattern 14C are additionally arranged on the front face of the first dielectric substrate 11, with respect to the central axis in the longitudinal direction (Y direction) of the signal conductor pattern 13A, and each of the following is provided: a sixth strip conductor pattern 23A that is a second coupling degree adjusting conductor pattern for adjusting the coupling degree that is a ratio of electromagnetic field coupling with the second stub conductor pattern 16A is disposed on the back face of the second dielectric substrate 21, a 15th strip conductor pattern 23B, which is a fifth coupling degree adjusting conductor pattern for adjusting a coupling degree that is a ratio of electromagnetic field coupling with the fifth stub conductor pattern 16B, and a 18th strip conductor pattern 23C, which is a sixth coupling degree adjusting conductor pattern for adjusting a coupling degree that is a ratio of electromagnetic field coupling with the sixth stub conductor pattern 16C, and the other points are the same.

In FIGS. 33 to 35, the same reference numerals as those attached in FIGS. 1 to 15 and FIGS. 20 to 27 denote the same or corresponding parts.

Hereinafter, the second stub conductor pattern 16A and the sixth strip conductor pattern 23A which is a second coupling degree adjusting conductor pattern, the fifth stub conductor pattern 16B and the 15th strip conductor pattern 23B which is a fifth coupling degree adjusting conductor pattern, and the sixth stub conductor pattern 16C and the 18th strip conductor pattern 23C which is a sixth coupling degree adjusting conductor pattern, which are differences from the high-frequency variable filter circuit according to the third embodiment, will be mainly described.

The high-frequency variable filter circuit according to the fourth embodiment includes the first substrate 10, the second substrate 20, and the movable plate 30.

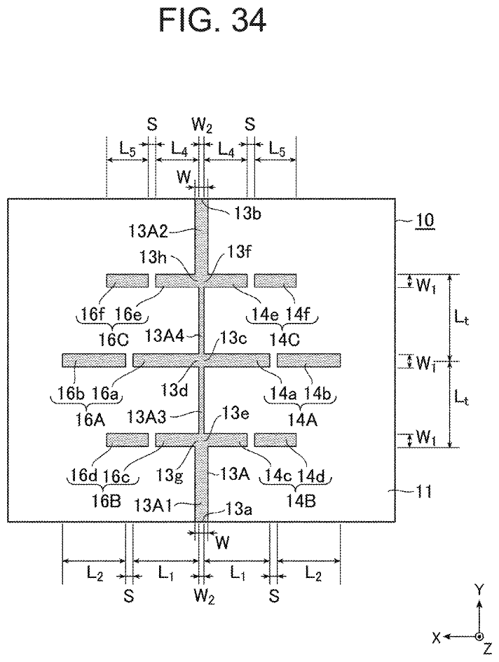

As illustrated in FIG. 34, the first substrate 10 includes the first dielectric substrate 11, the ground conductor 12, the signal conductor pattern 13A, the first stub conductor pattern 14A, the third stub conductor pattern 14B, the fourth stub conductor pattern 14C, the second stub conductor pattern 16A, the fifth stub conductor pattern 16B, and the sixth stub conductor pattern 16C.

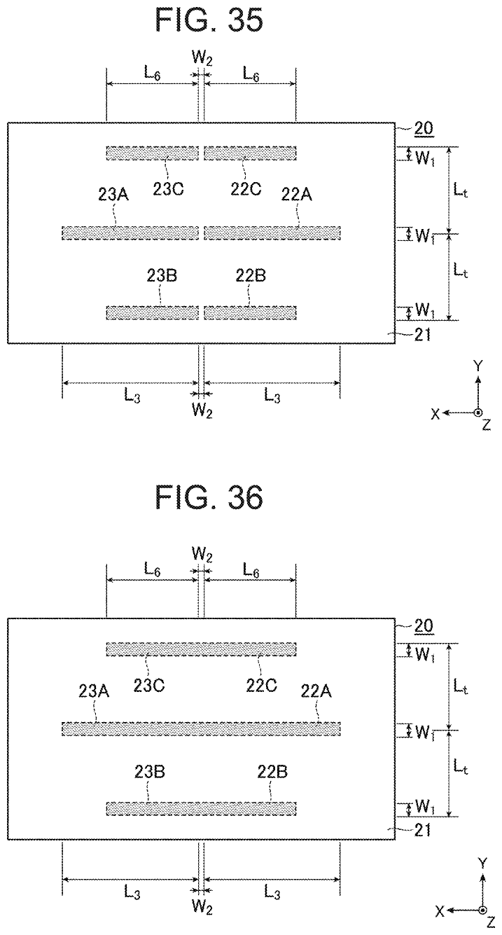

As illustrated in FIG. 35, the second substrate 20 includes the second dielectric substrate 21, a third strip conductor pattern 22A which is a first coupling degree adjusting conductor pattern, a ninth strip conductor pattern 22B which is a third coupling degree adjusting conductor pattern, a 12th strip conductor pattern 22C which is a fourth coupling degree adjusting conductor pattern, a sixth strip conductor pattern 23A which is a second coupling degree adjusting conductor pattern, a 15th strip conductor pattern 23B which is a fifth coupling degree adjusting conductor pattern, and a 18th strip conductor pattern 23C which is a sixth coupling degree adjusting conductor pattern.

Since the first dielectric substrate 11, the ground conductor 12, the signal conductor pattern 13A, the first stub conductor pattern 14A, the third stub conductor pattern 14B, and the fourth stub conductor pattern 14C are the same as the first dielectric substrate 11, the ground conductor 12, the signal conductor pattern 13A, the first stub conductor pattern 14A, the third stub conductor pattern 14B, and the fourth stub conductor pattern 14C in the high-frequency variable filter circuit according to the third embodiment, the description thereof is omitted.

In addition, since the second dielectric substrate 21, the third strip conductor pattern 22A, the ninth strip conductor pattern 22B, and the 12th strip conductor pattern 22C are the same as the second dielectric substrate 21, the third strip conductor pattern 22A, the ninth strip conductor pattern 22B, and the 12th strip conductor pattern 22C in the high-frequency variable filter circuit according to the third embodiment, the description thereof is omitted.

However, in the fourth embodiment, the width W₁ of the first strip conductor pattern 14a and the width W₁ of the second strip conductor pattern 14b constituting the first stub conductor pattern 14A, the width W₁ of the seventh strip conductor pattern 14c and the width W₁ of the eighth strip conductor pattern 14d constituting the third stub conductor pattern 14B, the width W₁ of the 10th strip conductor pattern 14e and the width W₁ of the 11th strip conductor pattern 14f constituting the fourth stub conductor pattern 14C are narrower than the width W of the signal conductor pattern 13A, the width W of the first strip conductor pattern 14a and the width W of the second strip conductor pattern 14b constituting the first stub conductor pattern 14A, the width W of the seventh strip conductor pattern 14c and the width W of the eighth strip conductor pattern 14d constituting the third stub conductor pattern 14B, and the width W of the 10th strip conductor pattern 14e and the width W of the 11th strip conductor pattern 14f constituting the fourth stub conductor pattern 14C in the high-frequency variable filter circuit according to the third embodiment.

Therefore, in the fourth embodiment, the occupation area in the connection portion 13c, which is the connection point between the first end of the first strip conductor pattern 14a and the first side portion of the joint portion between the first connection line portion 13A3 and the second connection line portion 13A4, the occupation area in the connection portion 13e, which is the connection point between the first end of the seventh strip conductor pattern 14c and the first side portion of the first connection line portion 13A3, and the occupation area in the connection portion 13f, which is the connection point between the first end of the 10th strip conductor pattern 14e and the second side portion of the second connection line portion 13A4, can be reduced, and the influence of the occupation area in each of the connection portions 13c, 13e, and 13f on the transmission characteristics (frequency characteristics) of the high-frequency signals propagating through the signal conductor pattern 13 is reduced.

In addition, the width W₁ of the third strip conductor pattern 22A, the width W₁ of the ninth strip conductor pattern 22B, and the width W₁ of the 12th strip conductor pattern 22C are narrower than the width W of the third strip conductor pattern 22A, the width W of the ninth strip conductor pattern 22B, and the width W of the 12th strip conductor pattern 22C in the high-frequency variable filter circuit according to the third embodiment.

The widths W₁ of the first strip conductor pattern 14a, the second strip conductor pattern 14b, and the third strip conductor pattern 22A are narrow, and coupled lines between the first strip conductor pattern 14a, the second strip conductor pattern 14b, and the third strip conductor pattern 22 have a high characteristic impedance.

The widths W₁ of the seventh strip conductor pattern 14c, the eighth strip conductor pattern 14d, and the ninth strip conductor pattern 22B are narrow, and coupled lines between the seventh strip conductor pattern 14c, the eighth strip conductor pattern 14d, and the ninth strip conductor pattern 22B have a high characteristic impedance.

The widths W₁ of the 10th strip conductor pattern 14e, the 11th strip conductor pattern 14f, and the 12th strip conductor pattern 22C are narrow, and coupled lines between the 10th strip conductor pattern 14e, the 11th strip conductor pattern 14f, and the 12th strip conductor pattern 22C have a high characteristic impedance.

The second stub conductor pattern 16A in the first substrate 10 is disposed on the front face of the first dielectric substrate 11 at a position mirror-image symmetric to the first stub conductor pattern 14A with respect to the central axis in the longitudinal direction (Y direction) of the signal conductor pattern 13A.

The second stub conductor pattern 16A includes a fourth strip conductor pattern 16a and a fifth strip conductor pattern 16b.

Between the second stub conductor pattern 16A and the ground conductor 12, the second stub conductor pattern 16A functions as a fourth capacitor for the fundamental waves of the high-frequency signals propagating through the signal conductor pattern 13A, and functions as a ¼-wavelength open-ended stub for the second harmonics of the fundamental waves.

The fourth strip conductor pattern 16a is a strip line formed on the front face of the first dielectric substrate 11, and constitutes a third stub transmission line together with the ground conductor 12, with the first dielectric substrate 11 interposed therebetween.

The fourth strip conductor pattern 16a is a linear conductor foil having a length L₁ and a width W₁, for example, a copper foil.

A first end of the fourth strip conductor pattern 16a is electrically connected to a second side face of the joint portion between the second end of the first connection line portion 13A3 and the first end of the second connection line portion 13A4 of the signal conductor pattern 13A, and the second end of the fourth strip conductor pattern 16a is an open end.

The fourth strip conductor pattern 16a, the first connection line portion 13A3 and the second connection line portion 13A4 of the signal conductor pattern 13A are conductor foils integrally formed.

The fourth strip conductor pattern 16a is orthogonal to the signal conductor pattern 13A, and is disposed on an extension line of the first strip conductor pattern 14a on the front face of the first dielectric substrate 11.

A connection point between the first end of the fourth strip conductor pattern 16a and the second side face of the signal conductor pattern 13A is referred to as a connection portion 13d.

Since the width W₁ of the fourth strip conductor pattern 16a is narrower than the width W, the area occupied by the connection portion 13d can be reduced, and the influence of the area occupied by the connection portion 13d on the transmission characteristics (frequency characteristics) of the high-frequency signals propagating through the signal conductor pattern 13 is reduced.

The fifth strip conductor pattern 16b is a strip line formed on the front face of the first dielectric substrate 11, and constitutes a fourth stub transmission line together with the ground conductor 12, with the first dielectric substrate 11 interposed therebetween.

The fifth strip conductor pattern 16b is a linear conductor foil having a length L₂ and a width W₁, for example, a copper foil.

Both ends of the fifth strip conductor pattern 16b are open ends, and an open end located at a first end of the fifth strip conductor pattern 16b is disposed with the spacing S from the second end of the fourth strip conductor pattern 16a.

The fifth strip conductor pattern 16b is disposed on an extension line of the fourth strip conductor pattern 16a.

That is, as illustrated in FIG. 34, the fourth strip conductor pattern 16a and the fifth strip conductor pattern 16b are arranged along a straight line in the X direction with the spacing S therebetween on the front face of the first dielectric substrate 11.

The fifth stub conductor pattern 16B is disposed on the front face of the first dielectric substrate 11 at a position mirror-image symmetric to the third stub conductor pattern 14B with respect to the central axis in the longitudinal direction (Y direction) of the signal conductor pattern 13A.

The fifth stub conductor pattern 16B includes a 13th strip conductor pattern 16c and a 14th strip conductor pattern 16d.

Between the fifth stub conductor pattern 16B and the ground conductor 12, the fifth stub conductor pattern 16B functions as a fifth capacitor for the fundamental waves of the high-frequency signals propagating through the signal conductor pattern 13A, and functions as a ¼-wavelength open-ended stub for the third harmonics of the fundamental waves.

The 13th strip conductor pattern 16c is a strip line formed on the front face of the first dielectric substrate 11, and constitutes a ninth stub transmission line together with the ground conductor 12, with the first dielectric substrate 11 interposed therebetween.

The 13th strip conductor pattern 16c is a linear conductor foil having a length L₄ (=L₁×⅔) and a width W₁, for example, a copper foil.

A first end of the 13th strip conductor pattern 16c is electrically connected to the first side face at the first end portion of the first connection line portion 13A3 of the signal conductor pattern 13A, and the second end of the 13th strip conductor pattern 16c is an open end.

The 13th strip conductor pattern 16c and the first connection line portion 13A3 of the signal conductor pattern 13A are conductor foils integrally formed.

The 13th strip conductor pattern 16c is orthogonal to the signal conductor pattern 13A, and is disposed on an extension line of the seventh strip conductor pattern 14c on the front face of the first dielectric substrate 11.

A connection point between the first end of the 13th strip conductor pattern 16c and the second side face of the signal conductor pattern 13A is referred to as a connection portion 13g.

Since the width W₁ of the 13th strip conductor pattern 16c is narrower than the width W, the area occupied by the connection portion 13g can be reduced, and the influence of the area occupied by the connection portion 13g on the transmission characteristics (frequency characteristics) of the high-frequency signals propagating through the signal conductor pattern 13 is reduced.

The 14th strip conductor pattern 16d is a strip line formed on the front face of the first dielectric substrate 11, and constitutes a 10th stub transmission line together with the ground conductor 12, with the first dielectric substrate 11 interposed therebetween.

The 14th strip conductor pattern 16d is a linear conductor foil having a length L₅ (=L₂×⅔) and a width W₁, for example, a copper foil.

Both ends of the 14th strip conductor pattern 16d are open ends, and an open end located at the first end of the 14th strip conductor pattern 16d is disposed with the spacing S from the second end of the 13th strip conductor pattern 16c.

The 14th strip conductor pattern 16d is disposed on an extension line of the 13th strip conductor pattern 16c.

That is, as illustrated in FIG. 34, the 13th strip conductor pattern 16c and the 14th strip conductor pattern 16d are arranged along a straight line in the X direction with the spacing S therebetween on the front face of the first dielectric substrate 11.

The sixth stub conductor pattern 16C is disposed on the front face of the first dielectric substrate 11 at a position mirror-image symmetric to the fourth stub conductor pattern 14C with respect to the central axis in the longitudinal direction (Y direction) of the signal conductor pattern 13A.

The sixth stub conductor pattern 16C includes a 16th strip conductor pattern 16e and a 17th strip conductor pattern 16f.

Between the sixth stub conductor pattern 16C and the ground conductor 12, the sixth stub conductor pattern 16C functions as a sixth capacitor for the fundamental waves of the high-frequency signals propagating through the signal conductor pattern 13A as well as functions as a ¼-wavelength open-ended stub for the third harmonics of the fundamental waves.

The 16th strip conductor pattern 16e is a strip line formed on the front face of the first dielectric substrate 11, and constitutes a 11th stub transmission line together with the ground conductor 12, with the first dielectric substrate 11 interposed therebetween.

The 16th strip conductor pattern 16e is a linear conductor foil having a length L₄ (=L₁×⅔) and a width W₁, for example, a copper foil.

A first end of the 16th strip conductor pattern 16e is electrically connected to the first side face at the second end of the second connection line portion 13A4 of the signal conductor pattern 13A, and the second end portion of the 16th strip conductor pattern 16e is an open end.

The 16th strip conductor pattern 16e and the second connection line portion 13A4 of the signal conductor pattern 13A are conductor foils integrally formed.

The 16th strip conductor pattern 16e is orthogonal to the signal conductor pattern 13A, and is disposed on an extension line of the seventh strip conductor pattern 14c on the front face of the first dielectric substrate 11.

A connection point between the first end of the 16th strip conductor pattern 16e and the second side face of the signal conductor pattern 13A is referred to as a connection portion 13h.

Since the width W₁ of the 16th strip conductor pattern 16e is narrower than the width W, the area occupied by the connection portion 13h can be reduced, and the influence of the area occupied by the connection portion 13h on the transmission characteristics (frequency characteristics) of the high-frequency signals propagating through the signal conductor pattern 13 is reduced.

The 17th strip conductor pattern 16f is a strip line formed on the front face of the first dielectric substrate 11, and constitutes a 12th stub transmission line together with the ground conductor 12, with the first dielectric substrate 11 interposed therebetween.

The 17th strip conductor pattern 16f is a linear conductor foil having a length L₅( L₂×⅔) and a width W₁, for example, a copper foil.

Both ends of the 17th strip conductor pattern 16f are open ends, and an open end located at the first end of the 17th strip conductor pattern 16f is disposed with the spacing S from the second end of the 16th strip conductor pattern 16e.

The 17th strip conductor pattern 16f is disposed on an extension line of the 16th strip conductor pattern 16e.

That is, the 16th strip conductor pattern 16e and the 17th strip conductor pattern 16f are arranged along a straight line in the X direction with the spacing S therebetween on the front face of the first dielectric substrate 11 as illustrated in FIG. 34.

The sixth strip conductor pattern 23A in the second substrate 20 is disposed on the back face of the second dielectric substrate 21 in such a manner as to face the fourth strip conductor pattern 16a and the fifth strip conductor pattern 16b.

That is, the sixth strip conductor pattern 23A is located immediately above the fourth strip conductor pattern 16a and the fifth strip conductor pattern 16b.

As illustrated in FIG. 35, the sixth strip conductor pattern 23A is disposed at a position mirror-image symmetric to the third strip conductor pattern 22A with respect to the central axis in the longitudinal direction of the signal conductor pattern 13A.

The sixth strip conductor pattern 23A is disposed along an extension line of the third strip conductor pattern 22A with a spacing therebetween equal to the width W₂ of the first connection line portion 13A3 and the second connection line portion 13A4 of the signal conductor pattern 13A.

That is, the third strip conductor pattern 22A and the sixth strip conductor pattern 23A are arranged along a straight line in the X direction with a spacing W₂ therebetween.

The sixth strip conductor pattern 23A is a linear conductor foil having a length L₃ (=L₁+L₂+S≈2×L₁) and a width W₁, for example, a copper foil.

The sixth strip conductor pattern 23A is a strip conductor parallel to the fourth strip conductor pattern 16a and the fifth strip conductor pattern 16b and, when having a distance d from the fourth strip conductor pattern 16a and the fifth strip conductor pattern 16b with electromagnetic field coupling ranging from tight coupling to loose coupling, forms a coupled line with the fourth strip conductor pattern 16a and the fifth strip conductor pattern 16b.

The widths W₁ of the fourth strip conductor pattern 16a, the fifth strip conductor pattern 16b, and the sixth strip conductor pattern 23A are narrow, and coupled lines between the fourth strip conductor pattern 16a, the fifth strip conductor pattern 16b, and the sixth strip conductor pattern 23A have high characteristic impedance.

Similarly to the third strip conductor pattern 22A, the sixth strip conductor pattern 23A is vertically moved by the second substrate 20 being vertically moved in a range from a contact state (coupling degree k=1) with the fourth strip conductor pattern 16a and the fifth strip conductor pattern 16b to a state sufficiently away from each other (coupling degree k=0).

By the sixth strip conductor pattern 23A being vertically moved, the fourth strip conductor pattern 16a and the fifth strip conductor pattern 16b, and the sixth strip conductor pattern 23A, can be caused to function as a ¼-wavelength open-ended stub in which the frequency for the second harmonics of the high-frequency signals propagating through the signal conductor pattern 13A is adjustable from the lower limit frequency f_{2L} to the upper limit frequency f_{2H}.

Further, by the sixth strip conductor pattern 23A being vertically moved, the resonance frequencies of the high-frequency signals propagating through the fourth strip conductor pattern 16a and the fifth strip conductor pattern 16b are adjusted from the lower limit frequency f_{2L} to the upper limit frequency f_{2H}, whereby the capacitance value of the second capacitor between the second stub conductor pattern 16A and the ground conductor 12 can be adjusted from the upper limit capacitance value C_{2H} to the lower limit capacitance value C_{2L}.

The 15th strip conductor pattern 23B is disposed on the back face of the second dielectric substrate 21 in such a manner as to face the 13th strip conductor pattern 16c and the 14th strip conductor pattern 16d.

That is, the 15th strip conductor pattern 23B is located immediately above the 13th strip conductor pattern 16c and the 14th strip conductor pattern 16d.

As illustrated in FIG. 35, the 15th strip conductor pattern 23B is disposed at a position mirror-image symmetric to the ninth strip conductor pattern 22B with respect to the central axis in the longitudinal direction of the signal conductor pattern 13A.

The 15th strip conductor pattern 23B is disposed along an extension line of the ninth strip conductor pattern 22B with a spacing therebetween equal to the width W₂ of the first connection line portion 13A3 of the signal conductor pattern 13A.

That is, the ninth strip conductor pattern 22B and the 15th strip conductor pattern 23B are arranged along a straight line in the X direction with a spacing W₂ therebetween.

The 15th strip conductor pattern 23B is a linear conductor foil having a length L₆ (=L₄+L₅+S≈2×L₅) and a width W₁, for example, a copper foil.

The 15th strip conductor pattern 23B is a strip conductor parallel to the 13th strip conductor pattern 16c and the 14th strip conductor pattern 16d and, when having a distance d from the 13th strip conductor pattern 16c and the 14th strip conductor pattern 16d with electromagnetic field coupling ranging from tight coupling to loose coupling, forms a coupled line with the 13th strip conductor pattern 16c and the 14th strip conductor pattern 16d.

The widths W₁ of the 13th strip conductor pattern 16c, the 14th strip conductor pattern 16d, and the 15th strip conductor pattern 23B are narrow, and coupled lines between the 13th strip conductor pattern 16c, the 14th strip conductor pattern 16d, and the 15th strip conductor pattern 23B have a high characteristic impedance.

Similarly to the ninth strip conductor pattern 22B, the 15th strip conductor pattern 23B is vertically moved by the second substrate 20 being vertically moved in a range from a contact state (coupling degree k=1) with the 13th strip conductor pattern 16c and the 14th strip conductor pattern 16d to a state sufficiently away from each other (coupling degree k=0).

By the 15th strip conductor pattern 23B being vertically moved, the 13th strip conductor pattern 16c, the 14th strip conductor pattern 16d, and the 15th strip conductor pattern 23B can be caused to function as a ¼-wavelength open-ended stub in which the frequency for the third harmonics of the high-frequency signals propagating through the signal conductor pattern 13A is adjustable from the lower limit frequency f_{3L} to the upper limit frequency f_{3H}.

Further, by the 15th strip conductor pattern 23B being vertically moved, the resonance frequencies of the high-frequency signals propagating through the 13th strip conductor pattern 16c and the 14th strip conductor pattern 16d are adjusted from the lower limit frequency f_{2L} to the upper limit frequency f_{2H}, whereby the capacitance value of the second capacitor between the second stub conductor pattern 16A and the ground conductor 12 can be adjusted from the upper limit capacitance value C_{2H} to the lower limit capacitance value C_{2L}.

The 18th strip conductor pattern 23C is disposed on the back face of the second dielectric substrate 21 in such a manner as to face the 16th strip conductor pattern 16e and the 17th strip conductor pattern 16f.

That is, the 18th strip conductor pattern 23C is located immediately above the 16th strip conductor pattern 16e and the 17th strip conductor pattern 16f.

As illustrated in FIG. 35, the 18th strip conductor pattern 23C is disposed at a position mirror-image symmetric to the 12th strip conductor pattern 22C with respect to the central axis in the longitudinal direction of the signal conductor pattern 13A.

The 18th strip conductor pattern 23C is disposed along an extension line of the 12th strip conductor pattern 22C with a spacing therebetween equal to the width W₂ of the second connection line portion 13A4 of the signal conductor pattern 13A.

That is, the 12th strip conductor pattern 22C and the 18th strip conductor pattern 23C are arranged along a straight line in the X direction with a spacing W₂ therebetween.

The 18th strip conductor pattern 23C is a linear conductor foil having a length L₆ (=L₄+L₅+S≈2×L₅) and a width W₁, for example, a copper foil.

The 18th strip conductor pattern 23C is a strip conductor parallel to the 16th strip conductor pattern 16e and the 17th strip conductor pattern 16f and, when having a distance d from the 16th strip conductor pattern 16e and the 17th strip conductor pattern 16f with electromagnetic field coupling ranging from tight coupling to loose coupling, forms a coupled line with the 16th strip conductor pattern 16e and the 17th strip conductor pattern 16f.

The widths W₁ of the 16th strip conductor pattern 16e, the 17th strip conductor pattern 16f, and the 18th strip conductor pattern 23C are narrow, and coupled lines between the 16th strip conductor pattern 16e, the 17th strip conductor pattern 16f, and the 18th strip conductor pattern 23C have a high characteristic impedance.

Similarly to the 12th strip conductor pattern 22C, the 18th strip conductor pattern 23C is vertically moved by the second substrate 20 being vertically moved in a range from a contact state (coupling degree k=1) with the 16th strip conductor pattern 16e and the 17th strip conductor pattern 16f to a state sufficiently away from each other (coupling degree k=0).

By the 18th strip conductor pattern 23C being vertically moved, it is possible to cause the 16th strip conductor pattern 16e, the 17th strip conductor pattern 16f, and the 18th strip conductor pattern 23C to function as a ¼-wavelength open-ended stub in which the frequency for the third harmonics of the high-frequency signals propagating through the signal conductor pattern 13A is adjustable from the lower limit frequency f_{3L} to the upper limit frequency f_{3H}.

Further, by the 18th strip conductor pattern 23C being vertically moved, the resonance frequencies of the high-frequency signals propagating through the 16th strip conductor pattern 16e and the 17th strip conductor pattern 16f are adjusted from the lower limit frequency f_{2L} to the upper limit frequency f_{2H}, whereby the capacitance value of the second capacitor between the second stub conductor pattern 16A and the ground conductor 12 can be adjusted from the upper limit capacitance value C₂H to the lower limit capacitance value C_{2L}.

In short, in the fourth embodiment, a low-pass filter is constituted by an L-C circuit constituted by two inductors connected in series between the connection portion 13e and the connection portion 13f by the first connection line portion 13A3 and the second connection line portion 13A4 with respect to the fundamental waves of the high-frequency signals propagating through the signal conductor pattern 13A, a first capacitor of the variable capacitance C₂ constituted by the first stub conductor pattern 14A connected to the connection portion 13c, a fourth capacitor of the variable capacitance C₂ constituted by the second stub conductor pattern 16A connected to the connection portion 13d and electrically connected in parallel to the first capacitor, a second capacitor of the variable capacitance C₃ constituted by the third stub conductor pattern 14B connected to the connection portion 13e, a fifth capacitor of variable capacitance C₃ constituted by the fifth stub conductor pattern 16B connected to the connection portion 13g, and electrically connected in parallel to the second capacitor, a third capacitor of variable capacitance C₃ constituted by the fourth stub conductor pattern 14C connected to the connection portion 13f, and a sixth capacitor of variable capacitance C₃ constituted by the sixth stub conductor pattern 1 cC connected to the connection portion 13g and electrically connected in parallel to the third capacitor.

In the low-pass filter configured as described above, with respect to the frequencies of the fundamental waves of the high-frequency signals propagated between the first input and output terminal 13a and the second input and output terminal 13b in the signal conductor pattern 13A, since the frequencies can be mechanically adjusted to frequencies between the lower limit frequency f_{1L} and the upper limit frequency f_{1H} corresponding to the distance d selected by the vertical movement of the second substrate 20, the variable frequency range is wide with respect to the frequencies of the fundamental waves, and the cutoff frequency of the low-pass filter can be adjusted with high accuracy in the range from the lower limit frequency f_{1L} to the upper limit frequency f_{1H}.

Further, in the fourth embodiment, the stub transmission line based on the third strip conductor pattern 22A, and the first strip conductor pattern 14a and the second strip conductor pattern 14b, and the stub transmission line based on the sixth strip conductor pattern 23A, and the fourth strip conductor pattern 16a and the fifth strip conductor pattern 16b can each mechanically adjust the frequency from the lower limit frequency f_{2L} to the upper limit frequency f_{2H} corresponding to the distance d selected by the vertical movement of the second substrate 20 with respect to the frequency of the second harmonics of the fundamental waves in the high-frequency signals propagated between the first input and output terminal 13a and the second input and output terminal 13b in the signal conductor pattern 13A, so that the variable frequency range is wide with respect to the frequencies of the second harmonics of the fundamental waves, and it is possible to accurately prevent propagation of the second harmonics of the fundamental waves propagating between the first input and output terminal 13a and the second input and output terminal 13b.

In the fourth embodiment, the stub transmission line based on the ninth strip conductor pattern 22B, and the seventh strip conductor pattern 14c and the eighth strip conductor pattern 14d, and the stub transmission line based on the 15th strip conductor pattern 23B, and the 13th strip conductor pattern 16c and the 14th strip conductor pattern 16d can each mechanically adjust the frequency from the lower limit frequency f_{3L} to the upper limit frequency f_{3H} corresponding to the distance d selected by the vertical movement of the second substrate 20 with respect to the frequency of the third harmonics of the fundamental waves in the high-frequency signals propagating from the first input and output terminal 13a to the second input and output terminal 13b in the signal conductor pattern 13A, so that the variable frequency range is wide with respect to the frequencies of the third harmonics of the fundamental waves, and it is possible to accurately prevent propagation of the third harmonics of the fundamental waves propagating from the first input and output terminal 13a to the second input and output terminal 13b.

In the fourth embodiment, the stub transmission line based on the 12th strip conductor pattern 22C, and the 10th strip conductor pattern 14e and the 11th strip conductor pattern 14f, and the stub transmission line based on the 18th strip conductor pattern 23c, and the 16th strip conductor pattern 16e and the 17th strip conductor pattern 16f can each mechanically adjust the frequency from the lower limit frequency f_{3L} to the upper limit frequency f_{3H} corresponding to the distance d selected by the vertical movement of the second substrate 20 with respect to the frequency of the third harmonics of the fundamental waves in the high-frequency signals propagating from the second input and output terminal 13b to the first input and output terminal 13a in the signal conductor pattern 13A, so that the variable frequency range is wide with respect to the frequencies of the third harmonics of the fundamental waves, it is possible to accurately prevent propagation of the third harmonics of the fundamental waves propagating from the second input and output terminal 13b to the first input and output terminal 13a.

As described above, the high-frequency variable filter circuit according to the fourth embodiment has effects similar to those of the high-frequency variable filter circuit according to the third embodiment, and also the influence on the transmission characteristics (frequency characteristics) with respect to the high-frequency signals propagating through the signal conductor pattern 13A is reduced.

As a result, the high-frequency variable filter circuit according to the fourth embodiment is suitable for use in a millimeter wave band in which a propagation wavelength is short.

Another example 1 of second substrate 20 in high-frequency variable filter circuit according to fourth embodiment

A configuration may be employed in which the third strip conductor pattern 22A and the sixth strip conductor pattern 23A, the ninth strip conductor pattern 22B and the 15th strip conductor pattern 23B, and the 12th strip conductor pattern 22C and the 18th strip conductor pattern 23C in the second substrate 20 are formed continuously with the spacing W₂ filled as illustrated in FIG. 36, instead of being arranged along a straight line with the spacing W₂ therebetween.

That is, the third strip conductor pattern 22A having a length L₃ and the sixth strip conductor pattern 23A having a length L₃, which are arranged at mirror-image symmetrical positions with respect to the central axis in the longitudinal direction of the signal conductor pattern 13A, are continuously formed as one strip conductor pattern having the length (2×L₃+W₂) on one straight line in the X direction on the back face of the second dielectric substrate 21.

In addition, the ninth strip conductor pattern 22B having a length L₆ and the 15th strip conductor pattern 23B having a length L₆, which are arranged at mirror-image symmetrical positions with respect to the central axis in the longitudinal direction of the signal conductor pattern 13A, are continuously formed as one strip conductor pattern having a length (2×L₆+W₂) on one straight line in the X direction on the back face of the second dielectric substrate 21.

Further, the 12th strip conductor pattern 22C having a length L₆ and the 18th strip conductor pattern 23C having a length L₆, which are arranged at mirror-image symmetrical positions with respect to the central axis in the longitudinal direction of the signal conductor pattern 13A, are continuously formed as one strip conductor pattern having a length (2×L₆+W₂) on one straight line in the X direction on the back face of the second dielectric substrate 21.

Another example 2 of second substrate 20 in high-frequency variable filter circuit according to fourth embodiment

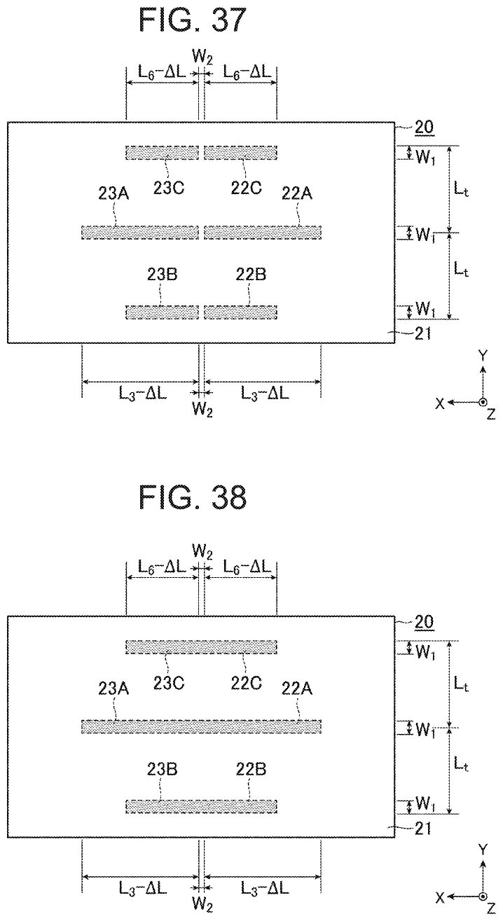

As illustrated in FIG. 37, the length of each of the third strip conductor pattern 22A and the sixth strip conductor pattern 23A in the second substrate 20 may be a length L₃′ (=L₃−ΔL) shorter by ΔL than the length L₃.

In addition, the length of each of the ninth strip conductor pattern 22B and the 15th strip conductor pattern 23B and the length of each of the 12th strip conductor pattern 22C and the 18th strip conductor pattern 23C may be a length L₆′ (=L₆−ΔL) shorter by ΔL than the length L₆ as illustrated in FIG. 37.

The length L₃′ is longer than the sum of the length L₁ and the spacing S, and is shorter than the sum of the length L₁, the length L₂, and the spacing S.

That is, the length L₃′ of the third strip conductor pattern 22A is a length in which the third strip conductor pattern 22A is electrically connected to the first strip conductor pattern 14a and the second strip conductor pattern 14b when the distance d is 0, and when the distance d exceeds 0, the third strip conductor pattern 22A forms the first coupled line with the first strip conductor pattern 14a and forms the second coupled line with the second strip conductor pattern 14b.

The length L₃′ of the sixth strip conductor pattern 23A is a length in which the sixth strip conductor pattern 23A is electrically connected to the fourth strip conductor pattern 16a and the fifth strip conductor pattern 16b when the distance d is 0, and when the distance d exceeds 0, the sixth strip conductor pattern 23 forms a third coupled line with the fourth strip conductor pattern 16a and forms a fourth coupled line with the fifth strip conductor pattern 16b.

The length L₆′ is longer than the sum of the length L₄ and the spacing S, and is shorter than the sum of the length L₄, the length L₅, and the spacing S.

That is, the length L₆′ of the ninth strip conductor pattern 22B is a length in which the ninth strip conductor pattern 22B is electrically connected to the seventh strip conductor pattern 14c and the eighth strip conductor pattern 14d when the distance d is 0, and when the distance d exceeds 0, the ninth strip conductor pattern 22B forms the fifth coupled line with the seventh strip conductor pattern 14c and forms the sixth coupled line with the eighth strip conductor pattern 14d.

The length L₆′ of the 15th strip conductor pattern 23B is a length in which the 15th strip conductor pattern 23B is electrically connected to the 13th strip conductor pattern 16c and the 14th strip conductor pattern 16d when the distance d is 0, and when the distance d exceeds 0, the 15th strip conductor pattern 23B forms the ninth coupled line with the 13th strip conductor pattern 16c and forms the 10th coupled line with the 14th strip conductor pattern 16d.

The length L₆′ of the 12th strip conductor pattern 22C is a length in which the 12th strip conductor pattern 22C is electrically connected to the 10th strip conductor pattern 14e and the 11th strip conductor pattern 14f when the distance d is 0, and when the distance d exceeds 0, the 12th strip conductor pattern 22C forms a seventh coupled line with the 10th strip conductor pattern 14e and forms an eighth coupled line with the 11th strip conductor pattern 14f.

The length L₆′ of the 18th strip conductor pattern 23C is a length in which the 18th strip conductor pattern 23C is electrically connected to the 16th strip conductor pattern 16e and the 17th strip conductor pattern 16f when the distance d is 0, and when the distance d exceeds 0, the 18th strip conductor pattern 23C forms the 11th coupled line with the 16th strip conductor pattern 16e and forms the 12th coupled line with the 17th strip conductor pattern 16f.

L₃′ has a relationship of (L₁+S)<L₃′<(L₁+L₂+S=L₃), and L₆′ has a relationship of (L₄+S)<L₆′<(L₄+L₅+S=L₆).

Further, ΔL is a sufficiently shorter range than the propagation wavelength of the fundamental wave in the high-frequency signal, for example, λ/10 or less.

In addition, ΔL only needs to exceed the maximum allowable range of the positional deviation in the longitudinal direction (X direction) of the third strip conductor pattern 22A and the sixth strip conductor pattern 23A of the second substrate 20 with respect to the first strip conductor pattern 14a and the fourth strip conductor pattern 16a of the first substrate 10, the positional deviation in the longitudinal direction of the ninth strip conductor pattern 22B and the 15th strip conductor pattern 23B of the second substrate 20 with respect to the seventh strip conductor pattern 14c and the 13th strip conductor pattern 16c of the first substrate 10, and the positional deviation in the longitudinal direction of the 12th strip conductor pattern 22C and the 18th strip conductor pattern 23C of the second substrate 20 with respect to the 10th strip conductor pattern 14e and the 16th strip conductor pattern 16e of the first substrate 10.

By setting ΔL in this manner, the frequency characteristics as the variable resonator are not affected.

Another example 3 of second substrate 20 in high-frequency variable filter circuit according to fourth embodiment

As illustrated in FIG. 38, instead of the configuration in which the third strip conductor pattern 22A and the sixth strip conductor pattern 23A in the second substrate 20 are arranged along a straight line with the spacing W₂ therebetween, the third strip conductor pattern 22A and the sixth strip conductor pattern 23A may be continuously formed with the spacing W₂ filled, and moreover, the length of each of the third strip conductor pattern 22A and the sixth strip conductor pattern 23A may be a length L₃′ (=L₃−ΔL) shorter by ΔL than the length L₃.

Further, instead of the configuration in which the ninth strip conductor pattern 22B and the 15th strip conductor pattern 23B in the second substrate 20 are arranged along a straight line with the spacing W₂ therebetween, the ninth strip conductor pattern 22B and the 15th strip conductor pattern 23B may be continuously formed with the spacing W₂ filled, and moreover, the length of each of the ninth strip conductor pattern 22B and the 15th strip conductor pattern 23B may be a length L₆′ (=L₆−ΔL) shorter by ΔL than the length L₆.

Further, instead of the configuration in which the 12th strip conductor pattern 22C and the 18th strip conductor pattern 23C are arranged along a straight line with the spacing W₂ therebetween, the 12th strip conductor pattern 22C and the 18th strip conductor pattern 23C may be continuously formed with the spacing W₂ filled, and moreover, the length of each of the 12th strip conductor pattern 22C and the 18th strip conductor pattern 23C may be a length L₆′ (=L₆−ΔL) shorter by ΔL than the length L₆.

That is, the third strip conductor pattern 22A having a length L₃′ (=L₃−ΔL) and the sixth strip conductor pattern 23A having a length L₃′ (=L₃−ΔL), which are arranged at mirror-image symmetrical positions with respect to the central axis in the longitudinal direction of the signal conductor pattern 13A, are continuously formed as one strip conductor pattern having a length (2×L₃′ (=L₃−ΔL)+W₂) along a straight line in the X direction on the back face of the second dielectric substrate 21.

The ninth strip conductor pattern 22B having a length L₆′ (=L₆−ΔL) and the 15th strip conductor pattern 23B having a length L₆′ (=L₆−ΔL), which are arranged at mirror-image symmetrical positions with respect to the central axis in the longitudinal direction of the signal conductor pattern 13A, are continuously formed as one strip conductor pattern having a length (2×L₆′ (=L₆−ΔL)+W₂) along a straight line in the X direction on the back face of the second dielectric substrate 21.

The 12th strip conductor pattern 22C having a length L₆′ (=L₆−ΔL) and the 18th strip conductor pattern 23C having a length L₆′ (=L₆−ΔL), which are arranged at mirror-image symmetrical positions with respect to the central axis in the longitudinal direction of the signal conductor pattern 13A, are continuously formed as one strip conductor pattern having a length (2×L₆′ (=L₆−ΔL)+W₂) along a straight line in the X direction on the back face of the second dielectric substrate 21.

### Fifth Embodiment

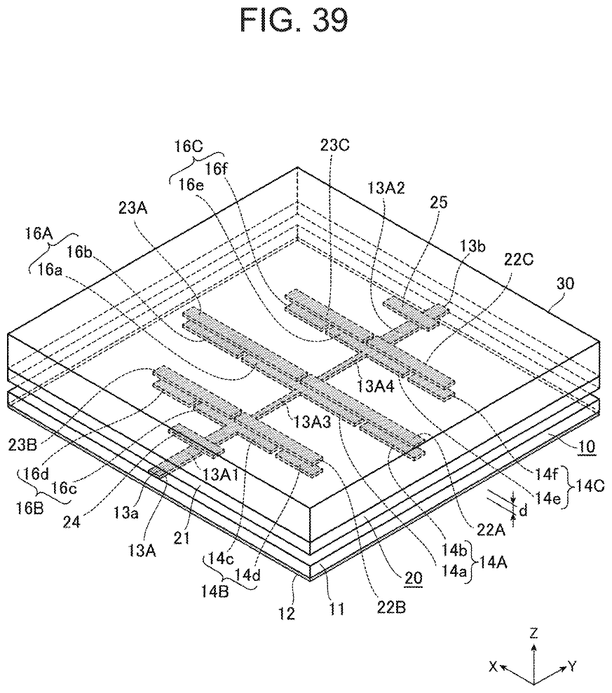

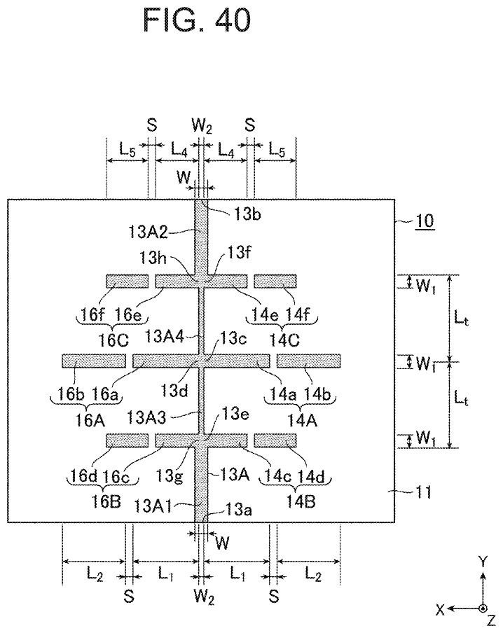

A high-frequency variable filter circuit according to a fifth embodiment will be described with reference to FIGS. 39 to 41.

The high-frequency variable filter circuit according to the fifth embodiment is different from the high-frequency variable filter circuit according to the fourth embodiment in that the first matching strip conductor pattern 24 and the second matching strip conductor pattern 25 are arranged on the back face of the second dielectric substrate 21, and the other points are the same.

In FIGS. 39 to 41, the same reference numerals as those attached in FIGS. 1 to 15, 20 to 27, and 33 to 35 denote the same or corresponding parts.

Hereinafter, the first matching strip conductor pattern 24 and the second matching strip conductor pattern 25, which are differences from the high-frequency variable filter circuit according to the fourth embodiment, will be mainly described.

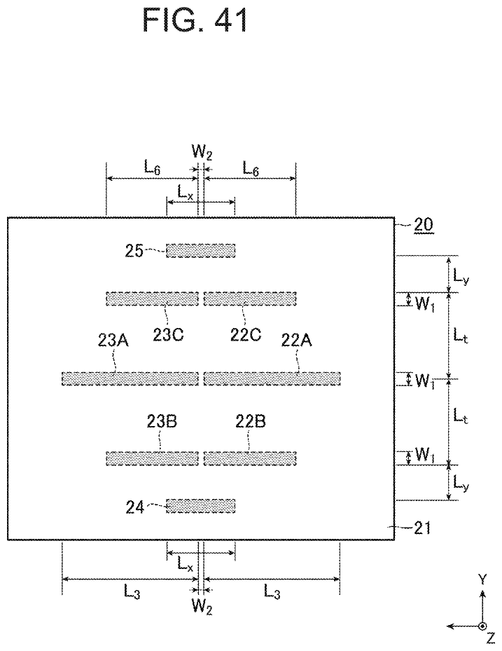

As illustrated in FIG. 41, the first matching strip conductor pattern 24 is disposed on the back face of the second dielectric substrate 21 in the second substrate 20 in such manner as to have a central portion facing the first input and output line portion 13A1 of the signal conductor pattern 13A in the first substrate 10, and extends orthogonal to the first input and output line portion 13A1, that is, in a direction (X direction) orthogonal to the longitudinal direction of the signal conductor pattern 13A.

The first matching strip conductor pattern 24 is disposed in parallel with the ninth strip conductor pattern 22B and the 15th strip conductor pattern 23B, and the spacing between the first side face of the first matching strip conductor pattern 24 and the second side face of the ninth strip conductor pattern 22B and the second side face of the 15th strip conductor pattern 23B is L_{y}.

The first matching strip conductor pattern 24 is a linear conductor foil having a length Lₓ and a width W₁, for example, a copper foil.

The central portion of the first matching strip conductor pattern 24 has the same length as the width of the first input and output line portion 13A1 of the signal conductor pattern 13A, and the left and right of the first matching strip conductor pattern 24 are arranged in mirror-image symmetrically with respect to the central portion.

The length Lₓ of the first matching strip conductor pattern 24 is shorter than the sum (2×L₆) of the length L₆ of the ninth strip conductor pattern 22B and the length L₆ of the 15th strip conductor pattern 23B (Lₓ<2×L₆).

The length Lₓ of the first matching strip conductor pattern 24 is less than ⅙ of the propagation wavelength at the lower limit frequency f_{1L} with respect to the fundamental waves of the high-frequency signals propagating to the signal conductor pattern 13A.

As illustrated in FIG. 41, the second matching strip conductor pattern 25 is disposed on the back face of the second dielectric substrate 21 in the second substrate 20 in such a manner as to have a central portion facing the second input and output line portion 13A2 of the signal conductor pattern 13A in the first substrate 10, and to extend in a direction orthogonal to the second input and output line portion 13A2, that is, orthogonal to the longitudinal direction of the signal conductor pattern 13A.

The second matching strip conductor pattern 25 is disposed in parallel with the 12th strip conductor pattern 22C and the 18th strip conductor pattern 23C, and the spacing between the second side face of the second matching strip conductor pattern 25 and the first side face of the 12th strip conductor pattern 22C and the first side face of the 18th strip conductor pattern 23C is L_{y}.

The second matching strip conductor pattern 25 is a linear conductor foil having a length Lₓ and a width W₁, for example, a copper foil.

The central portion of the second matching strip conductor pattern 25 has the same length as the width of the second input and output line portion 13A2 of the signal conductor pattern 13A, and the left and right of the second matching strip conductor pattern 25 are arranged in mirror-image symmetrically with respect to the central portion.

The length Lₓ of the second matching strip conductor pattern 25 is shorter than the sum (2×L₆) of the length L₆ of the 12th strip conductor pattern 22C and the length L₆ of the 18th strip conductor pattern 23C (Lₓ<2×L₆).

The length Lₓ of the second matching strip conductor pattern 25 is less than ⅙ of the propagation wavelength at the lower limit frequency f_{1L} with respect to the fundamental waves of the high-frequency signals propagating to the signal conductor pattern 13A.

When the second substrate 20 is vertically moved with respect to the first substrate 10 and the distance d, which is a spacing between the front face of the conductor pattern arranged on the front face of the first substrate 10 and the front face of the conductor pattern arranged on the back face of the second substrate 20, is zero (d=0), the central portion of the first matching strip conductor pattern 24 and the first input and output line portion 13A1 of the signal conductor pattern 13A are physically in contact with each other and conducted.

Therefore, the capacitor formed by the first matching strip conductor pattern 24 and the ground conductor 12 is electrically connected to the intersection of the first input and output line portion 13A1 with the central portion of the first matching strip conductor pattern 24.

The capacitor formed by the first matching strip conductor pattern 24 and the ground conductor 12 is impedance-matched in the passband including the lower limit frequency f_{1L} of the fundamental wave in the high-frequency signal propagating through the signal conductor pattern 13A when the distance d is zero.

Impedance matching is performed in the passband including the lower limit frequency f_{1L} of the fundamental wave, whereby the insertion loss in the passband including the lower limit frequency f_{1L} of the fundamental wave is reduced.

On the other hand, since the length of the first matching strip conductor pattern 24 is shorter than the sum of the length L₆ of the ninth strip conductor pattern 22B and the length L₆ of the 15th strip conductor pattern 23B, the first matching strip conductor pattern 24 does not affect the frequency characteristics at the lower limit frequency f_{2L} and frequencies in the vicinity including the frequency f_{2L} of the second harmonics of the fundamental waves and at the lower limit frequency f_{3L} and frequencies in the vicinity including the frequency f_{3L} of the third harmonics of the fundamental waves in the high-frequency signals propagating through the signal conductor pattern 13A when the distance d is in the zero state.

Therefore, the passage of the second harmonic and the third harmonic of the fundamental wave in the high-frequency signal propagating between the first input and output terminal 13a and the second input and output terminal 13b is prevented.

In a state where the second substrate 20 is vertically moved with respect to the first substrate 10, and the front face of the conductor pattern disposed on the front face of the first substrate 10 and the front face of the conductor pattern disposed on the back face of the second substrate 20 are not in contact with each other but the distance d is close to zero (d 0), a parallel plate capacitor is formed between the central portion of the first matching strip conductor pattern 24 and the first input and output line portion 13A1 of the signal conductor pattern 13A facing each other, and the parallel plate capacitor is electrically connected to an intersection of the first input and output line portion 13A1 and the central portion of the first matching strip conductor pattern 24.

The parallel plate capacitor is impedance-matched in a passband including the frequency of the fundamental wave in the high-frequency signal propagating through the signal conductor pattern 13A when the distance d is close to zero, that is, a frequency close to the lower limit frequency f_{1L}.

Impedance matching is performed in the passband including the frequency close to the lower limit frequency f_{1L} of the fundamental wave, whereby the insertion loss in the passband including the frequency close to the lower limit frequency f_{1L} of the fundamental wave is reduced.

The frequency characteristics at the lower limit frequency f_{2L} and frequencies in the vicinity including the frequency f_{2L} of the second harmonics of the fundamental waves and at the lower limit frequency f_{3L} and frequencies in the vicinity including the frequency f_{3L} of the third harmonics of the fundamental waves in the high-frequency signals propagating through the signal conductor pattern 13A when the distance d is close to zero are also not affected by the first matching strip conductor pattern 24.

When the second substrate 20 is vertically moved with respect to the first substrate 10, and the distance d between the front face of the conductor pattern arranged on the front face of the first substrate 10 and the front face of the conductor pattern arranged on the back face of the second substrate 20 is increased until the parallel plate capacitor is not formed, the configuration is similar to that of the high-frequency variable filter circuit according to the fourth embodiment.

Similarly, when the distance d is zero (d=0), the central portion of the second matching strip conductor pattern 25 and the second input and output line portion 13A2 of the signal conductor pattern 13A are in physical contact and conducted.

Therefore, the capacitor formed by the second matching strip conductor pattern 25 and the ground conductor 12 is electrically connected to the intersection of the second input and output line portion 13A2 with the central portion of the second matching strip conductor pattern 25.

The capacitor formed by the second matching strip conductor pattern 25 and the ground conductor 12 is impedance-matched in the passband including the lower limit frequency f_{1L} of the fundamental wave in the high-frequency signal propagating through the signal conductor pattern 13A when the distance d is zero.

Impedance matching is performed in the passband including the lower limit frequency f_{1L} of the fundamental wave, whereby the insertion loss in the passband including the lower limit frequency f_{1L} of the fundamental wave is reduced.

On the other hand, since the length of the second matching strip conductor pattern 25 is shorter than the sum of the length L₆ of the 12th strip conductor pattern 22C and the length L₆ of the 18th strip conductor pattern 23C, the second matching strip conductor pattern 25 does not affect frequency characteristics at the lower limit frequency f_{2L} and frequencies in the vicinity including the frequency f_{2L} of the second harmonics of the fundamental waves and at the lower limit frequency f_{3L} and frequencies in the vicinity including the frequency f_{3L}of the third harmonics of the fundamental waves in the high-frequency signals propagating through the signal conductor pattern 13A when the distance d is in the zero state.

Therefore, the passage of the second harmonic and the third harmonic of the fundamental wave in the high-frequency signal propagating between the first input and output terminal 13a and the second input and output terminal 13b is prevented.

In a state where the second substrate 20 is vertically moved with respect to the first substrate 10 and the distance d is close to zero (d≈0), a parallel plate capacitor is formed between the central portion of the second matching strip conductor pattern 25 and the second input and output line portion 13A2 of the signal conductor pattern 13A facing each other, and the parallel plate capacitor is electrically connected to the intersection of the second input and output line portion 13A2 and the central portion of the second matching strip conductor pattern 25.

The parallel plate capacitor is impedance-matched in a passband including the frequency of the fundamental wave in the high-frequency signal propagating through the signal conductor pattern 13A when the distance d is close to zero, that is, a frequency close to the lower limit frequency f_{1L}.

Impedance matching is performed in the passband including the frequency close to the lower limit frequency f_{1L} of the fundamental wave, whereby the insertion loss in the passband including the frequency close to the lower limit frequency f_{1L} of the fundamental wave is reduced.

The frequency characteristics at the lower limit frequency f_{2L} and frequencies in the vicinity including the frequency f_{2L} of the second harmonics of the fundamental waves and at the lower limit frequency f_{3L} and frequencies in the vicinity including the frequency f_{3L} of the third harmonics of the fundamental waves in the high-frequency signals propagating through the signal conductor pattern 13A when the distance d is close to zero are also not affected by the second matching strip conductor pattern 25.

When the second substrate 20 is vertically moved with respect to the first substrate 10, and the distance d between the front face of the conductor pattern arranged on the front face of the first substrate 10 and the front face of the conductor pattern arranged on the back face of the second substrate 20 is increased until the parallel plate capacitor is not formed, the configuration is similar to that of the high-frequency variable filter circuit according to the fourth embodiment.

As described above, the high-frequency variable filter circuit according to the fifth embodiment has effects similar to those of the high-frequency variable filter circuit according to the fourth embodiment, and further includes the first matching strip conductor pattern 24 and the second matching strip conductor pattern 25, so that impedance matching is performed at the lower limit frequency f_{1L} and the neighboring frequency (f₁ₘ≈f_{1L}) with respect to the fundamental waves of the high-frequency signals propagating to the signal conductor pattern 13A, whereby the insertion loss in the passband at the lower limit frequency f_{1L} and the neighboring frequencies with respect to the fundamental waves is reduced.

Note that the first matching strip conductor pattern 24 and the second matching strip conductor pattern 25 may be provided in the high-frequency variable filter circuit according to the third embodiment.

That is, in the third embodiment (see FIG. 24), the first matching strip conductor pattern 24 is formed of a linear conductor foil, for example, a copper foil, which has a portion facing the first input and output line portion 13A1 of the signal conductor pattern 13A in the first substrate 10, is disposed in parallel with the ninth strip conductor pattern 22B with a spacing L_{y}, and has a width W₁ shorter than the length L₆ of the ninth strip conductor pattern 22B.

The length of the first matching strip conductor pattern 24 is less than ⅙ of the propagation wavelength at the lower limit frequency f_{1L} with respect to the fundamental waves of the high-frequency signals propagating to the signal conductor pattern 13A.

The second matching strip conductor pattern 25 is formed of a linear conductor foil that has a portion facing the second input and output line portion 13A2 of the signal conductor pattern 13A in the first substrate 10, is disposed in parallel with the 12th strip conductor pattern 22C with a spacing L_{y}, and has a width W₁ whose length is shorter than the length L₆ of the 12th strip conductor pattern 22C, for example, a copper foil.

The length of the second matching strip conductor pattern 25 is less than ⅙ of the propagation wavelength at the lower limit frequency f_{1L} with respect to the fundamental waves of the high-frequency signals propagating to the signal conductor pattern 13A.

The high-frequency variable filter circuit configured as described above also has effects similar to those of the high-frequency variable filter circuit according to the third embodiment, and further includes the first matching strip conductor pattern 24 and the second matching strip conductor pattern 25, so that impedance matching is performed at the lower limit frequency f_{1L} and the neighboring frequency (f₁ₘ≈f_{1L}) with respect to the fundamental waves of the high-frequency signals propagating to the signal conductor pattern 13A, whereby the insertion loss in the passband at the lower limit frequency f_{1L} and the neighboring frequencies with respect to the fundamental waves is reduced.

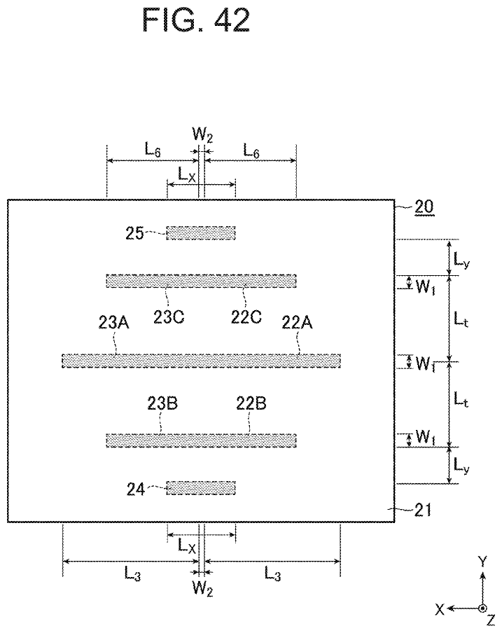

Another example 1 of second substrate 20 in high-frequency variable filter circuit according to fifth embodiment The third strip conductor pattern 22A and the sixth strip conductor pattern 23A, the ninth strip conductor pattern 22B and the 15th strip conductor pattern 23B, and the 12th strip conductor pattern 22C and the 18th strip conductor pattern 23C in the second substrate 20 may not be arranged along a straight line with the spacing W₂ therebetween, but may be formed continuously with the spacing W₂ filled as illustrated in FIG. 42.

That is, the third strip conductor pattern 22A having a length L₃ and the sixth strip conductor pattern 23A having a length L₃, which are arranged at mirror-image symmetrical positions with respect to the central axis in the longitudinal direction of the signal conductor pattern 13A, are continuously formed as one strip conductor pattern having the length (2×L₃+W₂) on one straight line in the X direction on the back face of the second dielectric substrate 21.

In addition, the ninth strip conductor pattern 22B having a length L₆ and the 15th strip conductor pattern 23B having a length L₆, which are arranged at mirror-image symmetrical positions with respect to the central axis in the longitudinal direction of the signal conductor pattern 13A, are continuously formed as one strip conductor pattern having a length (2×L₆+W₂) on one straight line in the X direction on the back face of the second dielectric substrate 21.

Further, the 12th strip conductor pattern 22C having a length L₆ and the 18th strip conductor pattern 23C having a length L₆, which are arranged at mirror-image symmetrical positions with respect to the central axis in the longitudinal direction of the signal conductor pattern 13A, are continuously formed as one strip conductor pattern having a length (2×L₆+W₂) on one straight line in the X direction on the back face of the second dielectric substrate 21.

Note that free combinations of the individual embodiments, modifications of any components of the individual embodiments, or omissions of any components in the individual embodiments are possible.

### INDUSTRIAL APPLICABILITY

The variable resonator according to the present disclosure is suitable for a variable resonator in a high-frequency variable filter circuit used for a communication device in a microwave and millimeter wave communication system.

In addition, the high-frequency variable filter circuit according to the present disclosure is suitable for a high-frequency variable filter circuit used in communication devices in microwave and millimeter wave communication systems, and is particularly preferably applied as a low pass filter.

### REFERENCE SIGNS LIST

10 first substrate, 11: first dielectric substrate, 12: ground conductor, 13, 13A: signal conductor pattern, 13A1: first input and output line portion, 13A2: second input and output line portion, 13A3: first connection line portion, 13A4: second connection line portion, 14: stub conductor pattern, 14A: first stub conductor pattern, 14B: third stub conductor pattern, 14C: fourth stub conductor pattern, 14a: first strip conductor pattern, 14b: second strip conductor pattern, 14c: seventh strip conductor pattern, 14d: eighth strip conductor pattern, 14e: 10th strip conductor pattern, 14f: 11th strip conductor pattern, 15: stub transmission line, 16: second stub conductor pattern, 16A: second stub conductor pattern, 16B: fifth stub conductor pattern, 16C: sixth stub conductor pattern, 16a: fourth strip conductor pattern, 16b: fifth strip conductor pattern, 16c: 13th strip conductor pattern, 16d: 14th strip conductor pattern, 16e: 16th strip conductor pattern, 16f: 17th strip conductor pattern, 20: second substrate, 21: second dielectric substrate, 22, 22A: third strip conductor pattern, 22B: ninth strip conductor pattern, 22C: 12th strip conductor pattern, 23, 23A: sixth strip conductor pattern, 23B: 15th strip conductor pattern, 23C: 18th strip conductor pattern, 24: first matching strip conductor pattern, 25: second matching strip conductor pattern, 30: movable plate

1. A variable resonator comprising:
a first substrate including a first dielectric substrate, a ground conductor disposed on a back face of the first dielectric substrate, a signal conductor pattern disposed on a front face of the first dielectric substrate, a first strip conductor pattern disposed on the front face of the first dielectric substrate and having a first end electrically connected to a first side face of the signal conductor pattern, and a second strip conductor pattern disposed on the front face of the first dielectric substrate with a spacing from a second end of the first strip conductor pattern;
a second substrate including a second dielectric substrate and a third strip conductor pattern disposed on a back face of the second dielectric substrate in such a manner as to face the first strip conductor pattern and the second strip conductor pattern; and
a movable plate connected to a front face of the second substrate, and movable in a front and back direction of the second substrate by a movable mechanism for moving the second substrate in the front and back direction, to adjust a distance between a front face of the first substrate and a back face of the second substrate.

2. The variable resonator according to claim 1, wherein
a length L₁ of the first strip conductor pattern is ¼ of a propagation wavelength at an upper limit frequency at which propagation of a high-frequency signal propagating to the signal conductor pattern is blocked,
a length L₃ of the third strip conductor pattern is ¼ of a propagation wavelength at a lower limit frequency at which propagation of a high-frequency signal propagating to the signal conductor pattern is blocked, and
a length L₂ of the second strip conductor pattern is a length obtained by subtracting a sum of the length L₁ and a spacing S between the second end of the first strip conductor pattern and a first end of the second strip conductor pattern from the length L₃.

3. The variable resonator according to claim 2, wherein the upper limit frequency is twice the lower limit frequency.

4. The variable resonator according to claim 1, wherein
the first substrate includes a fourth strip conductor pattern disposed on the front face of the first dielectric substrate and having a first end electrically connected to a second side face of the signal conductor pattern, and a fifth strip conductor pattern disposed on the front face of the first dielectric substrate with a spacing from a second end of the fourth strip conductor pattern, and
the second substrate includes a sixth strip conductor pattern disposed on the back face of the second dielectric substrate in such a manner as to face the fourth strip conductor pattern and the fifth strip conductor pattern.

5. The variable resonator according to claim 4, wherein
a length of the fourth strip conductor pattern is equal to a length of the first strip conductor pattern,
a length of the fifth strip conductor pattern is equal to a length of the second strip conductor pattern, and
a length of the sixth strip conductor pattern is equal to a length of the third strip conductor pattern.

6. The variable resonator according to claim 5, wherein
the fourth strip conductor pattern and the fifth strip conductor pattern are arranged mirror-image symmetrically with respect to a central axis in a longitudinal direction of the first strip conductor pattern and the second strip conductor pattern and the signal conductor pattern.

7. The variable resonator according to claim 6, wherein the third strip conductor pattern and the sixth strip conductor pattern are arranged along a straight line.

8. The variable resonator according to claim 7, wherein the third strip conductor pattern and the sixth strip conductor pattern are continuously formed.

9. The variable resonator according to claim 1, wherein
the first substrate includes a fourth strip conductor pattern disposed on the front face of the first dielectric substrate and having a first end electrically connected to a second side face of the signal conductor pattern, and a fifth strip conductor pattern disposed on the front face of the first dielectric substrate with a spacing from a second end of the fourth strip conductor pattern,
the second substrate has a sixth strip conductor pattern disposed on the back face of the second dielectric substrate in such a manner as to face the fourth strip conductor pattern and the fifth strip conductor pattern,
a length L₁ of each of the first strip conductor pattern and the fourth strip conductor pattern is ¼ of a propagation wavelength at an upper limit frequency at which propagation of a high-frequency signal propagating to the signal conductor pattern is blocked, and
when a length of each of the second strip conductor pattern and the fifth strip conductor pattern is L₂,
a length L₃ of each of the third strip conductor pattern and the sixth strip conductor pattern is longer than a sum of the length L₁ and a spacing S between the second end of the first strip conductor pattern and a first end of the second strip conductor pattern, and is shorter than a sum of the length L₁, the length L₂, and the spacing S.

10. A variable resonator comprising:
a first substrate that is a microstrip substrate including a first dielectric substrate, a ground conductor disposed on a back face of the first dielectric substrate, a signal conductor pattern disposed on a front face of the first dielectric substrate, and a stub conductor pattern disposed on the front face of the first dielectric substrate and having a first end electrically connected to the signal conductor pattern; and
a second substrate that is a coupling degree adjusting substrate to be relatively moved vertically with respect to the first substrate, the coupling degree adjusting substrate including a second dielectric substrate having a back face disposed in such a manner as to face the front face of the first dielectric substrate, and a coupling degree adjusting conductor pattern for adjusting a coupling degree that is a ratio of electromagnetic field coupling with the stub conductor pattern on a back face of the second dielectric substrate.

11. A high-frequency variable filter circuit comprising:
a first substrate including a first dielectric substrate, a ground conductor disposed on a back face of the first dielectric substrate, a signal conductor pattern disposed on a front face of the first dielectric substrate and having a first input and output line portion, a first connection line portion, a second connection line portion, and a second input and output line portion that are sequentially connected, a first strip conductor pattern disposed on the front face of the first dielectric substrate and having a first end electrically connected to a first side face at a joint portion between a second end of the first connection line portion and a first end of the second connection line portion of the signal conductor pattern, a second strip conductor pattern disposed on the front face of the first dielectric substrate with a spacing from a second end of the first strip conductor pattern, a seventh strip conductor pattern disposed on the front face of the first dielectric substrate and having a first end electrically connected to a first side face at a first end portion of the first connection line portion of the signal conductor pattern, an eighth strip conductor pattern disposed on the front face of the first dielectric substrate with a spacing from a second end of the seventh strip conductor pattern, a 10th strip conductor pattern disposed on the front face of the first dielectric substrate and having a first end electrically connected to a first side face at a second end portion of the second connection line portion of the signal conductor pattern, and an 11th strip conductor pattern disposed on the front face of the first dielectric substrate with a spacing from a second end of the 10th strip conductor pattern;
a second substrate including a second dielectric substrate, a third strip conductor pattern disposed on a back face of the second dielectric substrate in such a manner as to face the first strip conductor pattern and the second strip conductor pattern, a ninth strip conductor pattern disposed on the back face of the second dielectric substrate in such a manner as to face the seventh strip conductor pattern and the eighth strip conductor pattern, and a 12th strip conductor pattern disposed on the back face of the second dielectric substrate in such a manner as to face the 10th strip conductor pattern and the 11th strip conductor pattern; and
a movable plate connected to a front face of the second substrate, and movable in a front and back direction of the second substrate by a movable mechanism for moving the second substrate in the front and back direction, to adjust a distance between a front face of the first substrate and a back face of the second substrate.

12. The high-frequency variable filter circuit according to claim 11, wherein
a length L₁ of the first strip conductor pattern is ¼ of a propagation wavelength at an upper limit frequency at which propagation of a high-frequency signal propagating to the signal conductor pattern is blocked,
a length L₃ of the third strip conductor pattern is ¼ of a propagation wavelength at a lower limit frequency at which propagation of a high-frequency signal propagating to the signal conductor pattern is blocked,
a length L₂ of the second strip conductor pattern is a length obtained by subtracting a sum of the length L₁ and a spacing S between the second end of the first strip conductor pattern and a first end of the second strip conductor pattern from the length L₃, a length L₄ of each of the seventh strip conductor pattern and the 10th strip conductor pattern is ⅔ of the length L₁,
a length L₆ of each of the ninth strip conductor pattern and the 12th strip conductor pattern is ⅔ of the length L₃,
a length L₅ of the eighth strip conductor pattern is a length obtained by subtracting a sum of the length L₄ and the spacing S between the second end of the seventh strip conductor pattern and a first end of the eighth strip conductor pattern from the length L₆, and
a length L₅ of the 11th strip conductor pattern is a length obtained by subtracting a sum of the length L₄ and the spacing S between a second end of the ninth strip conductor pattern and a first end of the 11th strip conductor pattern from the length L₆.

13. The high-frequency variable filter circuit according to claim 12, wherein a high-frequency signal at which propagation of the high-frequency signal propagating to the signal conductor pattern is blocked is a second harmonic of a fundamental wave of the high-frequency signals propagating to the signal conductor pattern.

14. The high-frequency variable filter circuit according to claim 12, wherein the upper limit frequency is twice the lower limit frequency.

15. The high-frequency variable filter circuit according to claim 11, wherein the second substrate includes a first matching strip conductor pattern disposed in such a manner as to have a portion facing a first input and output line portion in the signal conductor pattern on the back face of the second dielectric substrate, and a second matching strip conductor pattern disposed in such a manner as to have a portion facing a second input and output line portion in the signal conductor pattern on the back face of the second dielectric substrate.

16. The high-frequency variable filter circuit according to claim 15, wherein a length of each of the first matching strip conductor pattern and the second matching strip conductor pattern is less than ⅙ of a propagation wavelength at a lower limit frequency with respect to a fundamental wave of a high-frequency signal propagating to the signal conductor pattern.

17. The high-frequency variable filter circuit according to claim 11, wherein
the first substrate includes a fourth strip conductor pattern disposed on the front face of the first dielectric substrate and having a first end electrically connected to a second side face at the joint portion between the second end of the first connection line portion and the first end of the second connection line portion of the signal conductor pattern, a fifth strip conductor pattern disposed on the front face of the first dielectric substrate with a spacing from a second end of the fourth strip conductor pattern, a 13th strip conductor pattern disposed on the front face of the first dielectric substrate and having a first end electrically connected to a second side face at the first end portion of the first connection line portion of the signal conductor pattern, a 14th strip conductor pattern disposed on the front face of the first dielectric substrate with a spacing from a second end of the 13th strip conductor pattern, and a 16th strip conductor pattern disposed on the front face of the first dielectric substrate, and having a first end electrically connected to a second side face at the second end portion of the second connection line portion of the signal conductor pattern, and a 17th strip conductor pattern disposed on the front face of the first dielectric substrate with a spacing from the second end of the 16th strip conductor pattern, and
the second substrate includes a sixth strip conductor pattern disposed on the back face of the second dielectric substrate in such a manner as to face the fourth strip conductor pattern and the fifth strip conductor pattern, a 15th strip conductor pattern disposed on the back face of the second dielectric substrate in such a manner as to face the 13th strip conductor pattern and the 14th strip conductor pattern, and an 18th strip conductor pattern disposed on the back face of the second dielectric substrate in such a manner as to face the 16th strip conductor pattern and the 17th strip conductor pattern.

18. The high-frequency variable filter circuit according to claim 17, wherein
a length of the fourth strip conductor pattern is equal to the length of the first strip conductor pattern,
a length of the fifth strip conductor pattern is equal to the length of the second strip conductor pattern,
a length of the sixth strip conductor pattern is equal to the length of the third strip conductor pattern,
a length of the 13th strip conductor pattern is equal to the length of the seventh strip conductor pattern,
a length of the 14th strip conductor pattern is equal to the length of the eighth strip conductor pattern,
a length of the 15th strip conductor pattern is equal to the length of the ninth strip conductor pattern,
a length of the 16th strip conductor pattern is equal to the length of the 10th strip conductor pattern,
a length of the 17th strip conductor pattern is equal to the length of the 11th strip conductor pattern, and
a length of the 18th strip conductor pattern is equal to the length of the 12th strip conductor pattern.

19. The high-frequency variable filter circuit according to claim 18, wherein
the fourth strip conductor pattern and the fifth strip conductor pattern are arranged mirror-image symmetrically with respect to a central axis in a longitudinal direction of the signal conductor pattern with respect to the first strip conductor pattern and the second strip conductor pattern,
the 13th strip conductor pattern and the 14th strip conductor pattern are arranged mirror-image symmetrically with respect to a central axis in a longitudinal direction of the signal conductor pattern and the seventh strip conductor pattern and the eighth strip conductor pattern, and
the 16th strip conductor pattern and the 17th strip conductor pattern are arranged mirror-image symmetrically with respect to a central axis in a longitudinal direction of the signal conductor pattern and the 10th strip conductor pattern and the 11th strip conductor pattern.

20. The high-frequency variable filter circuit according to claim 19, wherein
the third strip conductor pattern and the sixth strip conductor pattern are arranged along a straight line,
the ninth strip conductor pattern and the 15th strip conductor pattern are arranged along a straight line, and
the 12th strip conductor pattern and the 18th strip conductor pattern are arranged along a straight line.

21. The high-frequency variable filter circuit according to claim 20, wherein
the third strip conductor pattern and the sixth strip conductor pattern are continuously formed,
the ninth strip conductor pattern and the 15th strip conductor pattern are continuously formed, and
the 12th strip conductor pattern and the 18th strip conductor pattern are continuously formed.

22. The high-frequency variable filter circuit according to claim 12, wherein
the first substrate includes a fourth strip conductor pattern disposed on the front face of the first dielectric substrate and having a first end electrically connected to a second side face at the joint portion between the second end of the first connection line portion and the first end of the second connection line portion of the signal conductor pattern, a fifth strip conductor pattern disposed on the front face of the first dielectric substrate with a spacing from a second end of the fourth strip conductor pattern, a 13th strip conductor pattern disposed on the front face of the first dielectric substrate and having a first end electrically connected to a second side face at the first end portion of the first connection line portion of the signal conductor pattern, a 14th strip conductor pattern disposed on the front face of the first dielectric substrate with a spacing from a second end of the 13th strip conductor pattern, and a 16th strip conductor pattern disposed on the front face of the first dielectric substrate, and having a first end electrically connected to a second side face at the second end portion of the second connection line portion of the signal conductor pattern, and a 17th strip conductor pattern disposed on the front face of the first dielectric substrate with a spacing from the second end of the 16th strip conductor pattern,
the second substrate includes a sixth strip conductor pattern disposed on the back face of the second dielectric substrate in such a manner as to face the fourth strip conductor pattern and the fifth strip conductor pattern, a 15th strip conductor pattern disposed on the back face of the second dielectric substrate in such a manner as to face the 13th strip conductor pattern and the 14th strip conductor pattern, and an 18th strip conductor pattern disposed on the back face of the second dielectric substrate in such a manner as to face the 16th strip conductor pattern and the 17th strip conductor pattern,
a length L₁ of each of the first strip conductor pattern and the fourth strip conductor pattern is ¼ of a propagation wavelength at an upper limit frequency at which propagation of a high-frequency signal propagating to the signal conductor pattern is blocked, and
when a length of each of the second strip conductor pattern and the fifth strip conductor pattern is L₂,
a length L₃ of each of the third strip conductor pattern and the sixth strip conductor pattern is longer than a sum of the length L₁ and a spacing S between the second end of the first strip conductor pattern and a first end of the second strip conductor pattern, and is shorter than a sum of the length L₁, the length L₂, and the spacing S,
a length L₄ of each of the seventh strip conductor pattern, the 13th strip conductor pattern, the 10th strip conductor pattern, and the 16th strip conductor pattern is ⅔ of the length L₁,
a length of each of the eighth strip conductor pattern and the 14th strip conductor pattern, and the 11th strip conductor pattern and the 17th strip conductor pattern is L₅,
a length L₆ of each of the ninth strip conductor pattern and the 15th strip conductor pattern is longer than a sum of the length L₄ and a spacing S between the second end of the seventh strip conductor pattern and the first end of the eighth strip conductor pattern, and is shorter than a sum of the length L₄, the length L₅, and the spacing S, and
a length L₆ of each of the 12th strip conductor pattern and the 18th strip conductor pattern is longer than a sum of the length L₄ and a spacing S between a second end of the 11th strip conductor pattern and the first end of the 11th strip conductor pattern, and is shorter than a sum of the length L₄, the length L₅, and the spacing S.

23. The high-frequency variable filter circuit according to claim 17, wherein the second substrate includes a first matching strip conductor pattern having a central portion facing a first input and output line portion in the signal conductor pattern and disposed orthogonal to the first input and output line portion on the back face of the second dielectric substrate, and a second matching strip conductor pattern having a central portion facing a second input and output line portion in the signal conductor pattern and disposed orthogonal to the second input and output line portion on the back face of the second dielectric substrate.

24. The high-frequency variable filter circuit according to claim 23, wherein a length of each of the first matching strip conductor pattern and the second matching strip conductor pattern is less than ⅙ of a propagation wavelength at a lower limit frequency with respect to a fundamental wave of a high-frequency signal propagating to the signal conductor pattern.

25. The high-frequency variable filter circuit according to claim 23, wherein
a length of the first matching strip conductor pattern is shorter than a sum of a length of the ninth strip conductor pattern and a length of the 15th strip conductor pattern, and
a length of the second matching strip conductor pattern is shorter than a sum of a length of the 12th strip conductor pattern and a length of the 18th strip conductor pattern.

26. A high-frequency variable filter circuit comprising:
a first substrate including a first dielectric substrate, a ground conductor disposed on a back face of the first dielectric substrate, a signal conductor pattern disposed on a front face of the first dielectric substrate and having a first input and output line portion, a first connection line portion, a second connection line portion, and a second input and output line portion that are sequentially connected,
a first stub conductor pattern disposed on the front face of the first dielectric substrate, and having a first end electrically connected to a joint portion between a second end of the first connection line portion and a first end of the second connection line portion of the signal conductor pattern, to block passage of a second-order harmonic in a high-frequency signal propagating through the signal conductor pattern, a second stub conductor pattern disposed on the front face of the first dielectric substrate, and having a first end electrically connected to a first end portion of the first connection line portion of the signal conductor pattern, to block passage of a second-order harmonic in a high-frequency signal propagating through the signal conductor pattern, and a third stub conductor pattern disposed on the front face of the first dielectric substrate, and having a first end electrically connected to a second end portion of the second connection line portion of the signal conductor pattern, to block passage of a third-order harmonic in a high-frequency signal propagating through the signal conductor pattern, and
a second substrate that is a coupling degree adjusting substrate to be relatively moved vertically with respect to the first substrate, the coupling degree adjusting substrate including a second dielectric substrate having a back face disposed in such a manner as to face the front face of the first dielectric substrate, a first coupling degree adjusting conductor pattern to adjust a coupling degree that is a ratio of electromagnetic field coupling with the first stub conductor pattern on the back face of the second dielectric substrate, a second coupling degree adjusting conductor pattern to adjust a coupling degree that is a ratio of electromagnetic field coupling with the second stub conductor pattern on a back face of the second dielectric substrate, and a third coupling degree adjusting conductor pattern to adjust a coupling degree that is a ratio of electromagnetic field coupling with the third stub conductor pattern on a back face of the second dielectric substrate, the coupling degree adjusting substrate.
